(19) United States
(12) Patent Application Publication
(10) Pub. No.: US 2026/0220638 A1
(43) Pub. Date: Jul. 30, 2026

(54) METHODS AND DEVICES FOR ROUTING AUTHENTICATIONS USING A SWITCHBOARD NETWORK

(71) Applicant: Capital One Services, LLC, McLean, VA (US)

(72) Inventors: Kevin Osborn, Newton Highlands, MA (US); John Jones, Leesburg, VA (US); Casey Scott Barrett, Kensington, MD (US)

(21) Appl. No.: 19/041,665

(22) Filed: Jan. 30, 2025

(51) Int. Cl. G06Q 20/40; G06Q 20/34; G06Q 20/38

(52) U.S. Cl. CPC G06Q 20/4014; G06Q 20/352; G06Q 20/3825; G06Q 20/3829

(57) ABSTRACT

Methods and devices for routing authentication using a switchboard network are disclosed. A computing device accesses a merchant server hosting a website or application requiring personal data associated with a user account to process a transaction, the personal data being stored on an issuer server associated with a contactless card associated with the user account. The computing device receives a request from the merchant server to authenticate the user account and the contactless card responds and indicates the authentication method to be used, which is forwarded to a node in a switching network that extracts information from the response and determines the issuer server associated with the contactless card. The node initiates authentication of the user with an issuer server and retrieves personal data for the merchant server.

### BACKGROUND

Public key challenge authentication protocols such as FIDO2 by the fast identity online (FIDO) Alliance and passkeys are reliable in producing unforgeable authentications that may be facilitated using security keys stored on a user device. In FIDO-based systems, users will register with the authentication system (e.g., via a website) to log into their account. When accessing the user account, the user will not need to remember a password but can instead sign in with a passwordless authentication process using a FIDO private key locally stored. During the FIDO registration process, the authentication system will create an account for the new user device being registered and associate the FIDO public key from the user device with the user account being registered. The security keys are randomly generated and used in a authentication process to sign a FIDO challenge when accessing an online resource using FIDO-based security. However, the association of such authentication credentials (e.g., the FIDO signature, provided by a user device) to a trusted user identity, is generally based on user-provided identification credentials (e.g., username, password, government-issued identification) provided during the FIDO registration process and stored in an issuer server.

However, the identification credentials provided pre-registration are not tied to the authentication proof, namely the FIDO private key. There is a need for an authentication system that can utilize the FIDO2 authentication method and retrieve the identification credentials stored in the issuer server for further verification by the relying party, which may not be the same party as the issuing party associated with the website and, therefore, would not otherwise have access to the stored identification credentials.

### SUMMARY

The described subject matter relates to methods, devices, and systems for routing authentication using a switchboard network. An example method includes accessing, by a computing device, a merchant server hosting a website or application, the website or application requiring personal data associated with a user account to process a transaction, the personal data being stored on an issuer server associated with a contactless card associated with the user account. The method further includes receiving, by the computing device, a request from the merchant server to authenticate the user account, the request including a query from the merchant server to determine an authentication method by which the contactless card associated with the user account will authenticate the user account. The method further includes receiving, by the computing device from the contactless card, the response to the query, the response indicating the authentication method to be used by the contactless card. The method further includes sending, by the computing device, the response indicating the authentication method to a node in a switching network to extract information from the response and use the extracted information to determine the issuer server associated with the contactless card. The method further includes forwarding, by the computing device, an authentication request based on the indicated authentication method from the node in the switching network to the contactless card. The method further includes forwarding, by the computing device from the contactless card, an authentication response to the node in the switching network, where the node is to initiate authentication of the authentication response with the issuer server. The method further includes processing, by the computing device, a transaction with the merchant server, whereby the transaction is processed using the personal data that was sent from the node in the switching network to the merchant server as a result of the authentication by the node.

In an aspect of the described subject matter, the response to the query indicates that the authentication method to be used by the contactless card will be a fast identity online (FIDO) authentication method, wherein the authentication request comprises a FIDO authentication challenge, wherein the authentication response comprises a signed FIDO response using a FIDO private key, and wherein authenticating the authentication response comprises authenticating the signed FIDO response.

In an aspect of the described subject matter, the method further includes retrieving, by the computing device, protocol information about the contactless card using a FIDO client to authenticator protocol (CTAP) communication between the computing device and the contactless card.

In an aspect of the described subject matter, retrieving the protocol information includes determining the protocol information from the signed FIDO response and the authenticator attestation global unique identifier (AAGUID) of the contactless card.

In an aspect of the described subject matter, the information extracted from the response includes the protocol information from the AAGUID.

In an aspect of the described subject matter, the personal data includes at least payment credentials and personal information of the user account for shipping or delivery.

In an aspect of the described subject matter, the method further includes determining, by the computing device, the authentication method using sequential selection of AID.

In an aspect of the described subject matter, forwarding the response indicating the authentication method to the node in the switching network includes forwarding a user account identifier with the response, wherein the node in the switching network is to use the information extracted from the response with the user account identifier to query a database to determine the issuer server associated with the contactless card.

Another example method includes receiving, at a merchant server hosting a website or application, a transaction request from a computing device associated with a user account, the website or application requiring personal data associated with the user account to process the transaction request, and the personal data being stored on an issuer server associated with a contactless card associated with the user account. The method further includes sending, by the merchant server to the computing device, a request to authenticate the user account, the request including a query to determine an authentication method by which the contactless card associated with the user account will authenticate the user account. The method further includes receiving, by the merchant server, a response from the contactless card to the query, the response indicating the authentication method to be used by the contactless card. The method further includes forwarding, by the merchant server, the response to the query to a node in a switching network to extract information from the response, and use the extracted information to determine the issuer server associated with the contactless card, where the node in the switching network is to perform authentication using the issuer server. The method further includes receiving, by the merchant server from the node in the switching network, the personal data associated with the user account. The method further includes processing, by the merchant server, the transaction request using the personal data received from the node in the switching network.

In an aspect of the described subject matter, the response to the query indicates that the authentication method to be used by the contactless card will be a fast identity online (FIDO) authentication method, wherein the merchant server forwards a FIDO response signed by the contactless card to the node in the switching network to perform FIDO authentication.

In an aspect of the described subject matter, the method further includes receiving, by the merchant server, protocol information about the contactless card retrieved by a computing device using a FIDO client to authenticator protocol (CTAP) communication between the computing device and the contactless card.

In an aspect of the described subject matter, retrieving the protocol information includes determining the protocol information from the signed FIDO response and the authenticator attestation global unique identifier (AAGUID) of the contactless card.

In an aspect of the described subject matter, the personal data includes at least payment credentials and personal information of the user account for shipping or delivery.

In an aspect of the described subject matter, forwarding the response indicating the authentication method to the node in the switching network includes forwarding a user account identifier with the response, wherein the node in the switching network is to use the information extracted from the response with the user account identifier to query a database to determine the issuer server associated with the contactless card.

In an aspect of the described subject matter, a client software development kit (SDK) of the merchant server generates and sends the request, including the query, to the computing device to be forwarded to the contactless card.

Another example method includes receiving, at a node in a switching network, a message indicating an authentication method by which a contactless card will verify an identity of a user associated with a user account for processing a transaction with a merchant server, the merchant server requiring personal data regarding the user to process the transaction. The method further includes extracting, by the node in the switching network, information from the message to determine an issuer server associated with the contactless card and the user account. The method further includes sending, by the node in the switching network to the contactless card, an authorization request using the information extracted from the message. The method further includes verifying, by the node in the switching network, an authentication response from the contactless card and therefore verifying the identity of the user associated with the contactless card, where the node in the switching network sends the personal data to the merchant server and the transaction is processed using the personal data.

In an aspect of the described subject matter, the method further includes retrieving, by the node in the switching network, the personal data from the issuer server.

In an aspect of the described subject matter, the message indicates that the authentication method to be used by the contactless card will be a fast identity online (FIDO) authentication method, wherein the authentication request comprises a FIDO authentication challenge, wherein the authentication response comprises a signed FIDO response using a FIDO private key, and wherein verifying the authentication response comprises authenticating the signed FIDO response.

In an aspect of the described subject matter, the method further includes identifying, by the node in the switching network, a merchant identification associated with the merchant server, identifying a FIDO key associated with the merchant identification, wherein the node in the switching network verifies the authentication response using the FIDO key associated with the merchant identification.

In an aspect of the described subject matter, the method further includes generating, by the node in the switching network using the personal data and the signed FIDO response, an authorization token to process future transaction requests, the authorization token including an indication that the FIDO private key has already been verified for the user account, and verification of the FIDO private key is not needed for future transactions to be processed.

### BRIEF DESCRIPTION OF THE SEVERAL VIEWS OF THE DRAWINGS

FIG. 1 illustrates a connection system in accordance with embodiments of the described subject matter.

FIG. 2 includes a sequence flow illustrating an example authorization process using a switchboard network in accordance with embodiments of the described subject matter.

FIG. 3 is a flow chart of an example method for routing authentications using a switchboard network in accordance with embodiments of the described subject matter.

FIG. 4 is a flow chart of an example method for routing authentication conducted by a merchant server

FIG. 5 is a flow chart of an example method for routing authentication conducted by a switching network.

FIG. 6 is a flow chart of an example method for routing authentication conducted by a contactless card.

FIG. 7 is a flow chart of an example method for routing authentication conducted by an issuer server.

FIG. 8 illustrates a contactless card in accordance with embodiments of the described subject matter.

FIG. 9 illustrates a contactless card component in accordance with embodiments of the described subject matter.

FIG. 10 illustrates a sequence flow for providing authenticated access in accordance with embodiments of the described subject matter.

FIG. 11 illustrates a switchboard system configured to operate in accordance with embodiments of the described subject matter.

FIG. 12 illustrates a flow sequence for a client device to utilize DNS to resolve and communicate with one or more nodes of a switchboard network in accordance with embodiments of the described subject matter.

FIG. 13A illustrates a flow sequence to perform operations between a contactless card and services provided by a card issuer and/or merchant in accordance with embodiments of the described subject matter.

FIG. 13B illustrates a flow sequence to perform operations between a contactless card and services provided by a card issuer and/or merchant in accordance with embodiments of the described subject matter.

FIG. 13C illustrates a flow sequence to perform operations between a contactless card and services provided by a card issuer and/or merchant in accordance with embodiments of the described subject matter.

FIG. 14 illustrates an example message that may be communicated by a contactless card to perform functions described herein.

FIG. 15 is a flow chart illustrating various operations of an example method in accordance with embodiments of the described subject matter.

FIG. 16 illustrates a distributed network authentication system in accordance with embodiments of the described subject matter.

FIG. 17 is a flow chart illustrating a method performed by a distributed network authentication system in accordance with embodiments of the described subject matter.

### DETAILED DESCRIPTION

The systems and methods disclosed herein may be used to supplement authentication frameworks, including without limitation, Fast Identity Online (FIDO) authentication, Fast Identity Online 2 (FIDO2) authentication, WebAuthn, Client to Authenticator Protocol (CTAP) FIDO, Airkey authentication, and other authentication implementations. Systems and methods employed herein may be implemented with distributed storage, cloud-based storage, and other forms of storage in support of this functionality.

The systems and methods disclosed herein allow a user, when accessing a website or application hosted on an application server, to indicate with a contactless card the intended method of authorization to verify a user account associated with the website or application. For example, the user may indicate FIDO2 authentication as the intended method. The application server can utilize a switchboard network to conduct the authentication process and provide personal data of the user stored on an issuer server to the application server for verification of the user account. However, the FIDO2 authentication procedure does not readily identify the issuer of the FIDO authenticator associated with the user's FIDO private key. When a user creates and registers a FIDO private key, the user provides identity information, which the issuer server will store as the user's personal data in association with the FIDO public key corresponding to the FIDO private key. As described herein, the switchboard identifies the issuer of the FIDO authenticator using a signed certificate and an Authenticator Attestation Global Unique Identifier (AAGUID) of the authenticator. The switchboard then identifies the relying party, initiates the authentication with the issuer server, and retrieves the personal data stored in the issuer server.

In some instances, contactless card functions discussed herein may be utilized in a multi-issuer computing environment. These functions may include tap-to functions where a user may tap their contactless card on a device, such as a mobile device, to perform a function. For example, a user may utilize their contactless card to verify their identity, perform a payment, launch applications, log into applications, autofill a form or field, navigate to a specified web location or app on a device, unlock a door, initiate a contactless card, verify themselves, and so forth.

Further, embodiments discussed herein support tap-to mobile web experiences on both major mobile platforms (iOS®, Android®) by leveraging App Clips® and Javascript® SDK with WebNFC®. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apple's® App Store.

In the Android® operating system environment, embodiments include utilizing a JavaScript SDK. The JavaScript SDK may be installed into a website e.g., via source code. The JavaScript SDK also includes functions to support NFC communications between mobile devices and contactless cards via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner, and UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

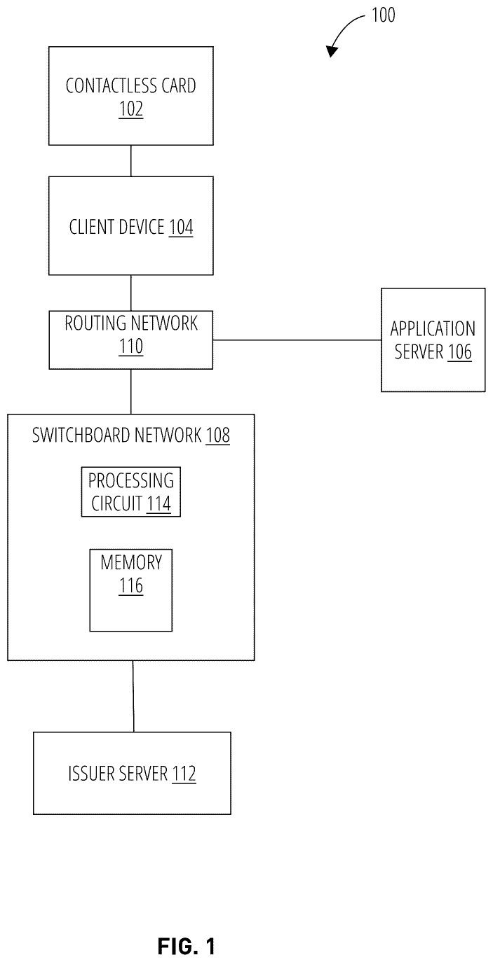

FIG. 1 illustrates a connection system 100 between a client device 104, an application server 106, and a switchboard network 108. The term switchboard network is used herein interchangeably with switching network. As further discussed below, the system 100 can also include a contactless card 102 and an issuer server 116. Although FIG. 1 illustrates single instances of the components, the system 100 may include any number of components. The contactless card 102 can communicate authorization information to the client device 104 via near field communication (NFC), BlueTooth®, Wi-Fi, radio-frequency identification (RFID), or any other suitable protocol. In instances where the client device 104 is actually a personal computer, a laptop, or any other computing device that does not have native NFC or RFID communication possible, the computing device may be equipped with an NFC or RFID reader and the FIDO communications can be passed from the contactless card 102 to the computing device via the NFC/RFID reader.

The routing network 110 can include one or more of a wireless network, a wired network or any combination of wireless network and wired network. For example, the routing network 110 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 1402.11 family of networking, Bluetooth, NFC, Radio Frequency Identification (RFID), Wi-Fi, and/or the like.

In addition, the routing network 110 may include, without limitation, telephone lines, fiber optics, IEEE Ethernet 1402.3, a wide area network, a wireless personal area network, a LAN, or a global network such as the Internet. The routing network 110 may support an Internet network, a wireless communication network, a cellular network, or the like, or any combination thereof. The routing network 110 may further include one network, or any number of the exemplary types of networks mentioned above, operating as a stand-alone network or in cooperation with each other. The routing network 110 may utilize one or more protocols of one or more network elements to which they are communicatively coupled. The routing network 110 may translate to or from other protocols to one or more protocols of network devices. Although the routing network 110 is depicted as a single network, it should be appreciated that according to one or more examples, the routing network 110 may comprise a plurality of interconnected networks, such as, for example, the Internet, a service provider's network, a cable television network, corporate networks, such as credit card association networks, and home networks.

The client device 104, application server 106, switchboard network 108, and issuer server 112 can each include at least one processor and a memory to perform steps described herein, a network connection, and be communicatively connected to each other via routing network 110 or any other suitable network such as a local area network (LAN), mobile communications network (e.g., 2G, 3G, 4G, LTE, 5G, 6G, etc.), wide area network (WAN), wireless LAN (WLAN), or any other suitable network.

The client device 104 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client device, a fat client device, an Internet browser, or other device. The client device 104 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The application server 106 hosts an application or website for which a user of the client device 104 wishes to access or login to. The application server 106 can include one or more servers of a party relying on authentication of a user who attempts to access or login to the application or website, also referred to herein as the relying party. The relying party can include, without limitation, a bank, merchant, or service provider. For example, the application server 106 can host a mobile banking application (e.g., credit card account application) or a merchant application (e.g., an application for goods or services) and the user of the client device 104 can have a user account associated therewith.

The user account can execute a mobile application on the client device 104 and attempt to login to the application or website that is hosted on the application server 106. In some embodiments, a user can access on the client device 104 the application or website of the relying party hosted on the application server 106. The application server 106 can receive a login request and communicate with the switchboard network 108 to authenticate the user account associated with the user's user account into which the user is attempting to login. As discussed in further detail herein, the switchboard network 108, which includes at least one processing circuit 114 coupled to memory 116 to perform the steps described herein, communicates with the contactless card 102 via the client device 104 to initiate authentication, with the issuer server 112, of the user account attempting to login to the application server 110. In response to the authentication request, the client device 104 can respond, using information received from the contactless card 102, either to the application server 106 that forwards the response to the switchboard network 108 or directly to the switchboard network 108. Once the issuer server 112 verifies or authenticates the user account, the switchboard network 108 sends a message to the application server 106 indicating that the user account has been validated or authenticated and thereby, the user is permitted by the application server 106 to access services of the application server 106, including performing a transaction.

The processing circuitry of the client device 104 may contain additional components, including processors, memories, error and parity/CRC checkers, data encoders, anticollision algorithms, controllers, command decoders, security primitives and tamperproofing hardware, as necessary to perform the functions described herein. The client device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

The contactless card 102 can indicate one of a number of possible methods by which the contactless card 102 associated with the user will authenticate the user account. In some embodiments, the user can select an intended authentication method on the client device 104 using the input devices. For example, the contactless card 102 can be configured for multiple authentication methods, which it identifies and sends to the client device 104. The client device 104 can then display the available authentication methods for the user to select via the input devices.

The contactless card 102 via the client device 104 can respond to the query from the application server 106 indicating that the method of authentication will be FIDO2 authentication. As known by those having ordinary skill in the art, FIDO2 authentication uses public key cryptography techniques to provide an authentication method using cryptographic key pairs called passkeys. During registration with an online service, a user device creates and stores a private key bound to the web service domain of the online service and registers the corresponding public key with the online service. A user subsequently accesses the online service not by using the typical “username” and “password” combination. Instead, the online service sends a FIDO2 authentication challenge to the user device. The user signs the challenge by verifying the login on the user device, which can include providing biometric verification, such as the user scanning a fingerprint or perform facial recognition on the client device 104, inputting a local PIN, or communicating a FIDO security key to the client device 104, such as inserting a hardware key (e.g., on a flash drive) into the client device 104. The FIDO challenge is signed using the FIDO private key, so the signed challenge proves possession of the private key. In embodiments of the described subject matter implementing FIDO2 authentication, during registration with an online service, such as a service provided by a website or application on the application server 106, the contactless card 102 creates and stores a FIDO private key bound to the web service domain of the website or application and registers the corresponding FIDO public key with the website or application on the application server 106. When a user subsequently attempts to access the website or application on the application server 106 using FIDO2 authentication, the application server 106 sends a FIDO authentication challenge to the client device 104. The authenticator on the client device 104 signs the challenge using the FIDO private key. The switchboard network 108 uses the signed FIDO challenge with a corresponding public FIDO key from the issuer server 112 to authenticate the user account as described herein. The switchboard network 108 then retrieves personal data of the user stored in the issuer server 112 and provides it to the application server 106 for verification.

The contactless card 102 via the client device 104 can respond to the query from the application server 106 indicating that the method of authentication will be an Airkey authentication. At the time of manufacture, one or more master keys used in Airkey authentication can be stored in contactless card 102 and duplicates of the master keys are also stored in a backend database, which can also be referred to herein as the issuer server 112 in reference to Airkey authentication. In embodiments of the described subject matter implementing Airkey authentication, the indication that the Airkey authentication will be used includes an issuer identification that the switchboard network 108 uses to identify the duplicate master key stored by the issuer server 112. The issuer server 112 can use the duplicate master key to authenticate the user account. In some embodiments, the switchboard network 108 retrieves the master key from the issuer server 112 and provides the master key to a validator to authenticate the user account.

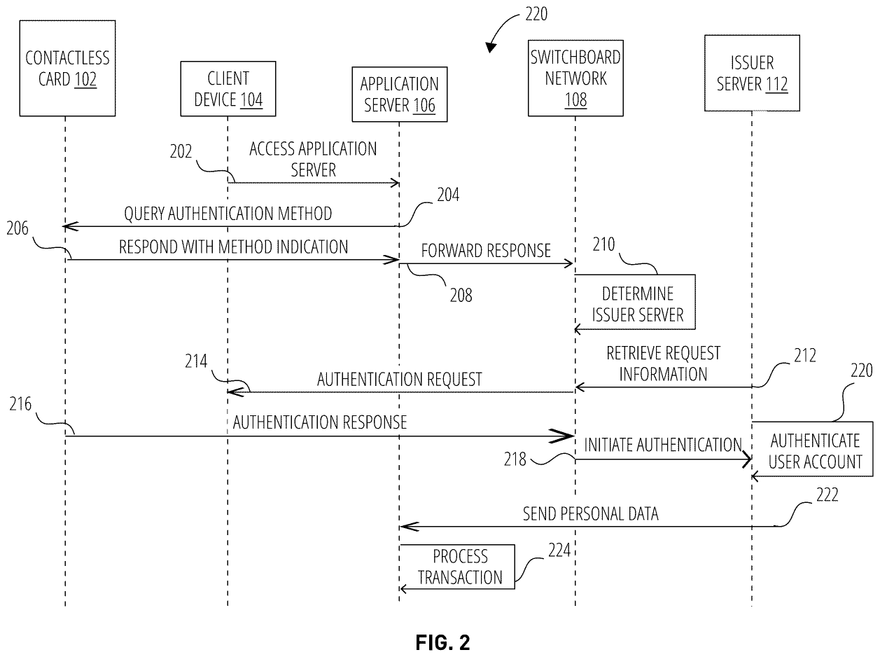

FIG. 2 includes a sequence flow illustrating an example authorization process 200 using the switchboard network 108 to authorize a user of a user account for a website or application hosted by a relying party on the application server 106 that requires personal data of the user stored on the issuer server 112. At step 202, the client device 104 accesses the application server 106 hosting a website or application. The application server 106 can receive information from the client device 104 to uniquely identify the user, such as the user's name, username, social security number, or email address. The website or application requires personal data associated with the contactless card 102 associated with the user's user account to process a transaction. The personal data can include data indicative of, for example, government-issued identification such as a driver's license or passport, social security number, birth certificate, or any data that uniquely identifies the user. The personal data can be stored on the issuer server 112 and is indicative of the identity information provided by the user during pre-registration of passkeys. Accessing the application server 106 can include being directed to the website or application of the relying party and inputting an indication of a desire to login to a user account or perform a restricted task, such as transfer funds on a banking website or conduct a transaction on a merchant application.

At step 204, the application server 106 sends the client device 104 a request to authenticate the user account. The request for authentication includes a query from the application server 106 to determine an authentication method by which the contactless card 102 associated with the user account will authenticate the user account. At step 204, the client device 104 forwards the request to the contactless card 102.

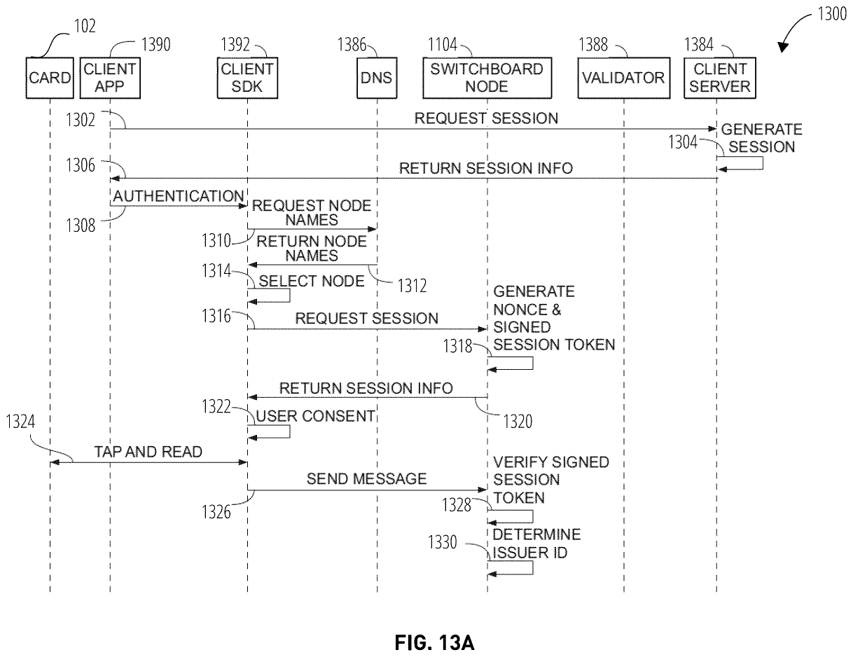

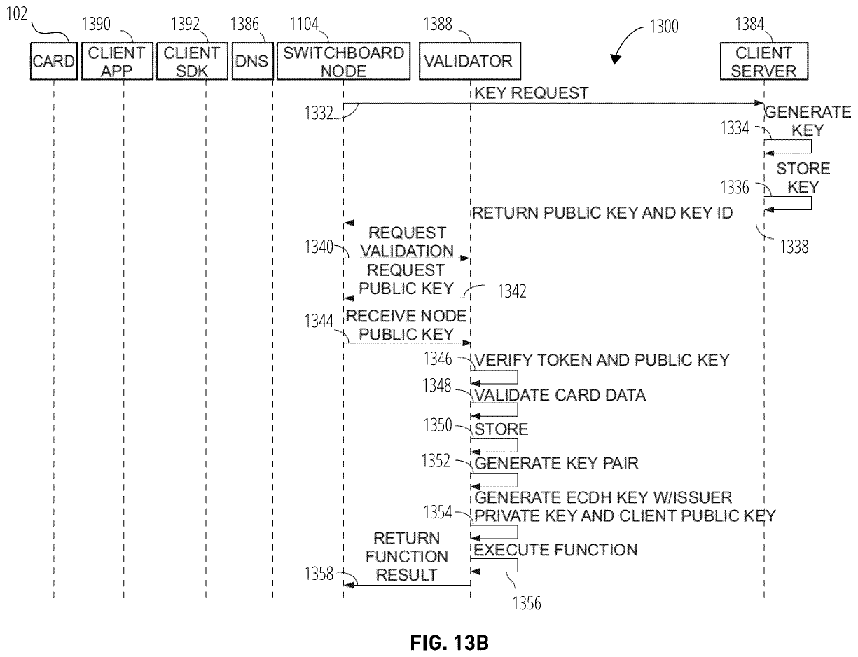

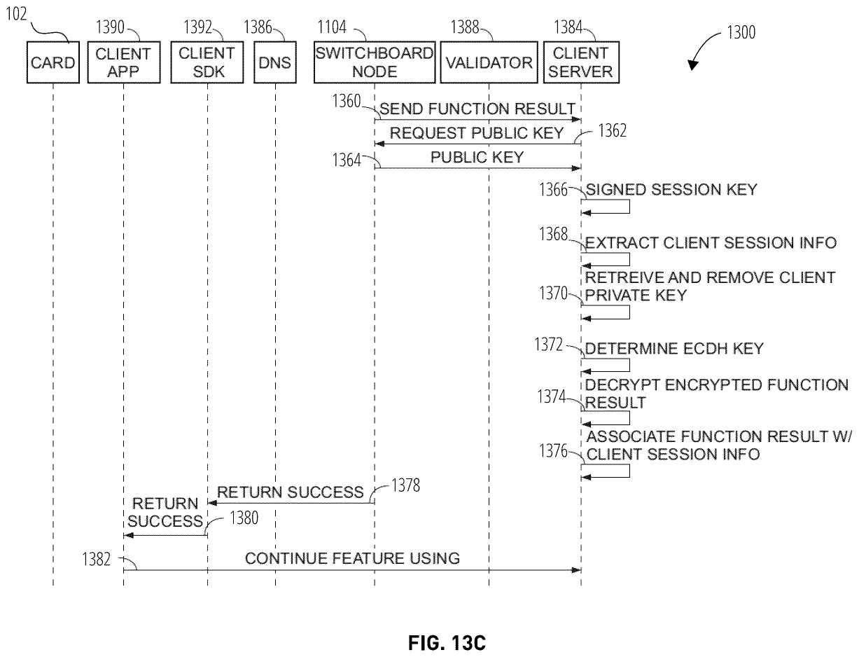

At step 206, the contactless card 102 sends to the client device 104 a response to the authentication request, including a response to the query, indicating the intended authentication method to be used by the contactless card 102. The client device 104 forwards the authentication response to the application server 106. The contactless card 102 can include an applet for each authentication method, such as an applet for FIDO2 authentication, an applet for Airkey authentication, etc. In some embodiments, a user can select the authentication method to be used for authenticating the user account, for example Airkey, FIDO2, etc. In some embodiments, the user can pre-select the authentication method or input on the client device 104 in real time a selected authentication method. The contactless card 102, application server 106, and/or client device 104 can pre-select a default authentication method, which the user may be able to change. In some embodiments, the client device 104 can slot in and select an alternative protocol and include any necessary flags to identify the selected alternative protocol in the response to the application server 106 so the application server 106 or switchboard network 108 can identify the selected protocol. In embodiments, the SDK in the client device 104, such as client SDK 1392 shown in FIGS. 13A-13C, can query the contactless card 102 by sequentially selecting the authentication identifications (AIDs) to determine the selected authentication method. Specifically, the SDK can search for listed AIDs one at a time and, if the search returns not found, search for the next possible AID until the SDK finds an AID. In some embodiments, the SDK can determine the selected authentication method by matching the format of one or more field values filled by the contactless card 102 to the applet that uses the same format, such as a specific number or a specific amount of digits in a field value.

In embodiments, if Airkey is the selected authentication method, the SDK in the client device 104 can select the AID of NFC NDEF type 4 application applet ID. An indication that Airkey is the authentication method will also, per Airkey protocol, include issuer identification. In another example, if FIDO is selected as the authentication method, the SDK in the client device 104 can select the client authenticator protocol (CTAP) applet ID and retrieve protocol information regarding the FIDO2 authentication using CTAP communication with the contactless card 102. If FIDO2 is selected as the AID, the SDK will retrieve CTAP protocol information in FIDO2 AID fields and corresponding field values, such as RID 0xA000000647 and PIX 0x2F0001. The FIDO specification includes additional CTAP protocol fields that the website or application on the application server 106 can include to provide additional constraints to the intended authentication method. For example, the application server 106 can include, in an assertion to the client device 104, the Enterprise ID field and can include restraints such as a particular merchant, category of merchants, and/or category of authenticators, to restrict the authentication method indicated by the contactless card 102 that the application server 106 will accept.

The SDK can retrieve protocol information, such as information about the authenticator of the FIDO passkey held by the user, including a signed certificate and an AAGUID of the authenticator. Using at least a portion of the AAGUID, the client device 104 can retrieve the signed certificate from a FIDO Alliance database that stores the signed certificates. It is understood that the signed certificate and/or the AAGUID are assigned such that they can be mapped to a specific issuer, i.e., a specific issuer server 112. For example, the signed certificate and/or AAGUID can indicate that the authenticator was pre-registered with the issuer or otherwise bound to the identity of the user. The AAGUID is a unique identifier of the authenticator. In some embodiments, the AAGUID can be segmented only a first portion of the AAGUID is shared with the SDK as an identification for the issuer, which the client device 104, application server 106, or switchboard network 108 can use to look up the whole AAGUID and use a second portion of the AAGUID to look up and retrieve the signed certificate for the authenticator. In other embodiments, the client device 104, application server 106, or switchboard network 108 can receive the whole AAGUID from the authenticator on the client device 104 and use the AAGUID as a whole to retrieve the signed certificate.

In some embodiments, rather than selecting a FIDO authentication method that implements FIDO passkeys or an Airkey authentication method, the user can select on the client device 104 an issuing bank where another type of passkey that the user holds, such as a YubiKey, is registered. YubiKey is a passkey that is stored in an external memory stick with a USB-port and NFC capabilities, allowing the passkey to be read by the client device 104. The YubiKey passkey is registered with the issuer server 112 that stores a corresponding passkey. YubiKey is compatible with the FIDO authentication method and the steps described herein following a FIDO authentication selection similarly apply to the process following a user selection of an issuing back of a YubiKey.

In some embodiments, the relying party associated with the website or application may require the identity of the authenticator before proceeding with the authentication process to ensure that the authenticator for the selected authentication method is included in a pre-approved list, allowing the relying party to avoid authentication methods involving untrusted authenticators. The application server 106 can request from the client device 104 the identity of the authenticator or determine the identity of the authenticator using the received information as described herein. If the authenticator is included among the pre-approved authenticators, then the application server 106 proceeds to step 208. Otherwise, the application server 106 may send a message to the client device 104 indicating that the authentication method is not approved and request that the user select another authentication method.

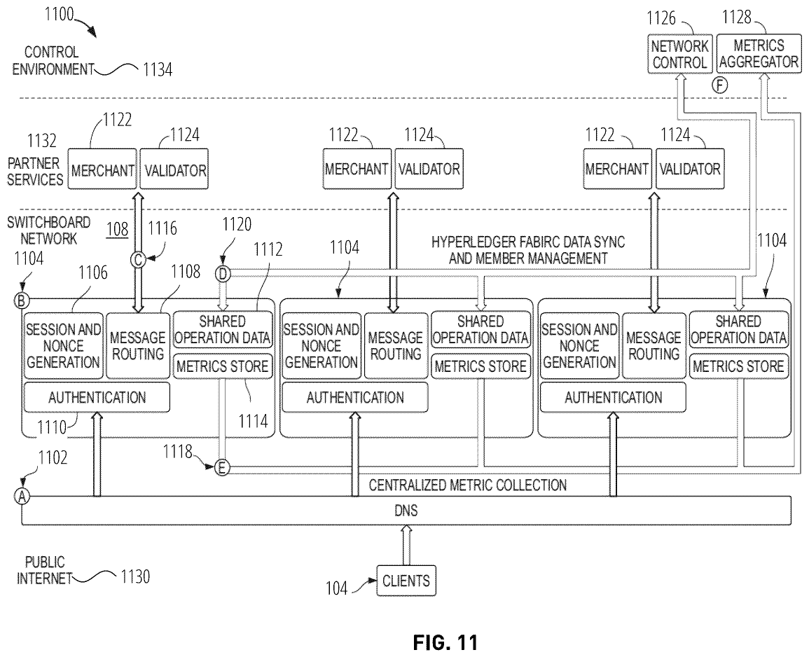

At step 208, the application server 106 forwards at least a portion of the authentication response from the contactless card 102 to the switchboard network 108 including the indication of the authentication method. In some embodiments, the application server 106 sends to the switchboard network 108 a request to authenticate the user of the user account and can include in the request an indication of the appropriate authentication protocol corresponding to the selected authentication method. Application server 106 can also include in the request to the switchboard network 108 at least one additional identifier of the user account such as a name, username, or email address of the user. The additional identifier can be retrieved by the application server 106 from user input when the user accesses the website or application. It is understood that any reference to the switchboard network 108 in the description regarding FIG. 2 can be a specific node 1104 among a plurality of nodes in the switchboard network 108, as shown in FIG. 11, such as a specific server in the switchboard network 108.

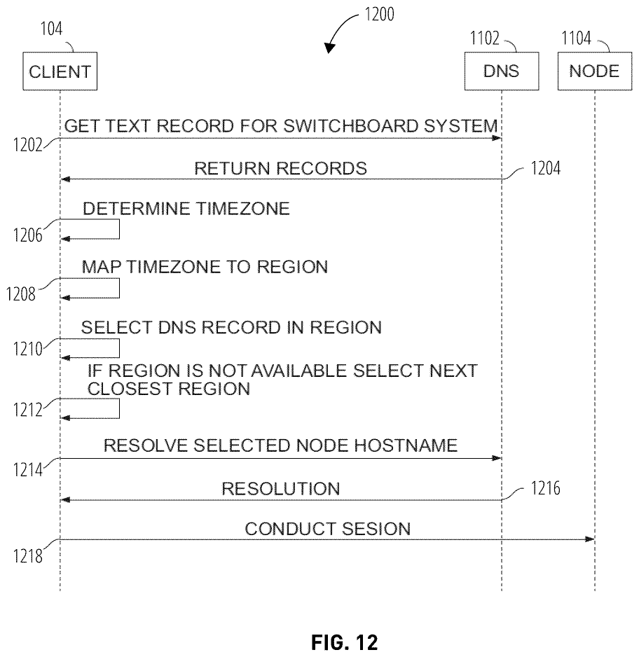

In some embodiments, the client device 104 can send the authentication response directly to the switchboard network 108. The steps described in FIG. 2 can include or be performed with the steps described in FIGS. 12 and 13A-13C. For example, in some embodiments, prior to the client device 104 sending the authentication response to the switchboard network 108, the client device 104 can perform the steps described in FIGS. 12 and 13A-13C to select the node 1104 in the switchboard network 108, resolve the hostname of the selected node 1104, and commence a session with the switchboard network 108. Similarly, the switchboard network 108 can generate a signed session token, which may be a JSON Web Token (JWT), to validate the session, as described herein with reference to FIGS. 13A-13C. In embodiments where the application server 106 forwards at least a portion of the authentication response to the switchboard network 108, the application server 106, instead of the client device 104, can select the node 1104, resolve the hostname of the selected node 1104, and commence a session with the switchboard network 108.

In some embodiments, the switchboard network 108 can authenticate with the client device 104 prior to proceeding to step 210. The authentication with the user can be performed directly between the switchboard network 108 and the client device 104. For example, the switchboard network 108 can ping the client device 104 associated with the contactless card 102, requesting confirmation that the user requested an authentication. The ping can include identifying information of the transaction for which the authentication is being requested, such as the owner or brand name of the application or website, the currency amount of the transaction, one or more items being purchased in the transaction, and the time of the request. The switchboard network 108 can send a message to the client device 104 requesting the user to tap the contactless card 102 to the client device 104. The messages transmitted between the contactless card 102 and the client device 104 can include authentication processes as described herein in which the client device 104 transmits to the switchboard network 108 at least a portion of the information received from the contactless card 102. If the switchboard network 108 does not receive a valid response from the client device 104 within a defined time period, the switchboard network 108 may repeat the authentication directly with the client device 104 or terminate the present authentication request and not proceed to step 210. In some embodiments, the switchboard network 108 can have or receive an active authentication token associated with the user and can bypass the direct authentication with the client device 104 and proceed to step 210. For example, present authentication request to the switchboard network 108 may be conducted during the same session in which the user had already been authenticated and the switchboard network 108 had signed a session token.

At step 210, the switchboard network 108 extracts information from the authentication response, specifically from the response by the contactless card 102 to the query to determine an authentication method, and uses the extracted information to determine the issuer server 112 associated with the contactless card 102 and with the selected authentication method of the contactless card 102. The switchboard network 108 can use the received at least one additional identifier with the extracted information to determine the issuer server 112. The extracted information can include protocol information described in step 206, such as the protocol information from the AAGUID. The issuer server 112 associated with the contactless cards 102 has stored the personal data of the user associated with the contactless card 102. If the user selected an issuing bank as the authentication method, then the switchboard network 108 can determine the issuer server 112 associated with the identified bank. If the selected authentication method is an Airkey authentication, then the switchboard network 108 can use the issuer identification in the response to determine the issuer server 112 of the specific issuing financial institution. If the selected authentication method is FIDO2 authentication, then the switchboard network 108 can extract information from the signed certificate and/or AAGUID of the authenticator to identify the issuer server 112. For a FIDO2 authentication, the switchboard network 108 can then look up in a database or table the relying party identification associated with the FIDO passkey held by the user. In some embodiments, the signed certificate can identify the relying party and the switchboard network 108 can retrieve the relying party identification from the signed certificate.

The switchboard network 108 then initiates authentication of the user account by first retrieving authentication request information from the identified issuer server 112 in step 212. In step 214, the switchboard network 108 then sends to the client device 104 an authentication request using the authentication information from the issuer server 112. The authentication request can include instructions displayed on the client device 104 for the user to tap the contactless card 102 card to the client device 104. At step 216, the contactless card 102 provides a response to the authentication request to the client device 104, which forwards the response to the switchboard network 108. If the selected authentication method is the FIDO2 authentication, the retrieved authentication request information at step 212 is the FIDO authentication challenge, the authentication request sent to the client device 104 at step 214 includes the FIDO authentication challenge, and at step 216 the applet for FIDO2 authentication on the contactless card 102 processes the FIDO authentication challenge and signs the challenge, wherein the response to the authentication request by the client device 104 is a signed FIDO challenge, which is signed using a FIDO private key stored on the applet or memory of the contactless card 102. Specifically, the authentication response implementing a FIDO2 authentication method is signed by the contactless card 102 with encrypted data (the enciphered FIDO challenge that was signed into the FIDO response) derived from the FIDO private key stored on the memory of the contactless card.

For Airkey authentication, at step 212, the retrieved authentication request information includes a request for the user to provide an encrypted payload. At step 216, the contactless card responds by generating an encrypted payload using a master key saved on the contactless card 102 as described herein. The message can include the master key used and/or a session key that the contactless card 102 generated based on the master key. The contactless card 102 can encrypt the message with the master key or the session key.

At step 218, the switchboard network 108 initiates the authentication of the user account. At step 220, the issuer server 112 authenticates the user account by verifying the received authentication response. For a FIDO2 authentication, at step 218, the switchboard network 108 forwards the authentication response from the contactless card 102, specifically the signed FIDO challenge, to the issuer server 112 for the issuer server 112 to conduct the authentication. The switchboard network 108 can send to the issuer server 112 the relying party identification, which is the party associated with the website or application. The relying party identification is necessary to identify the correct passkey because an authenticator can support multiple relying parties and each relying party has distinct FIDO keys. At step 220, the issuer server 112 can use the relying party identification to identify the stored FIDO public key that is paired with the user's FIDO private key and, using the FIDO public key, verify the authentication response, which authenticates the user account.

If the Airkey authentication method was selected, at step 218, the switchboard network 108 can forward the authenticaiton response by the contactless card 102 to a validator, such as the validator 1388 shown in FIGS. 13A-13C. The validator also retrieves the duplicate master key from the issuer server 112 and uses the duplicate master key to decipher the encrypted payload that was generated by the contactless card 102 to authenticate the user account.

Upon completion of the authentication, the user authentication proof, such as the FIDO private key, and the user's identification credentials, such as the personal data, are tied together. The signed session token described herein can be used by the user as a temporary identity binding for the duration of the current session between the client device 104 and the switchboard network 108. The user can then utilize the signed session token to conduct transactions with other relying parties, such as merchants partnering with the initial relying partner or banking institutions. The signed session token can include an expiration so the token expires when the session ends, the original FIDO challenge, the FIDO public key used by the switchboard network 108, issuer identification, an identifier of the validator used, and the information from the original payload.

In step 222, after authentication of the user account, the issuer server 112 sends the stored personal data supplied by the user during the registration of the user account to the switchboard network 108, which forwards the personal data to the application server 106 to compare it with the pre-registration identity information of the user account. Once the application server 106 confirms that the received personal data matches the pre-registration identity information of the user account, the authentication is complete and the client device 104 is permitted to proceed with processing the transaction with the application server 106.

At step 224, the application server 106 processes the transaction based on the confirmed match between the personal data received from the switchboard network 108 and the pre-registration identity information. The retrieved personal data can include payment credentials such as a bank account number or credit card number, a shipping address, billing address, telephone number, and the like, which the application server 106 can utilize to streamline a transaction process.

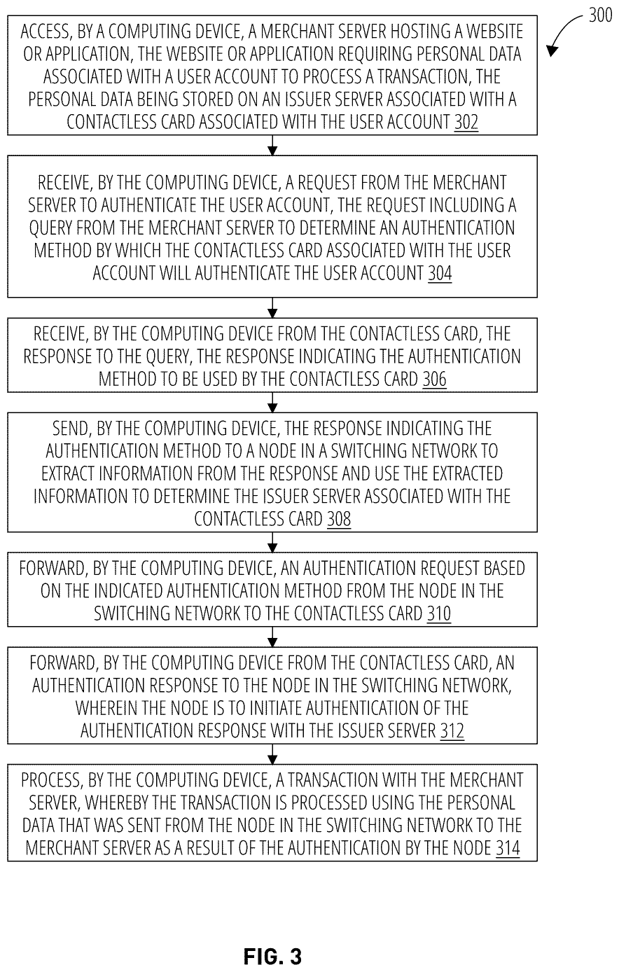

FIG. 3 is a flow chart of an example method 300 for routing authentications using a switchboard network. In block 302, a computing device accesses a merchant server hosting a website or application. The website or application requires personal data associated with a user account to process a transaction. The personal data is stored on an issuer server associated with a contactless card associated with the user account. The personal data can include at least payment credentials and personal information of the user account for shipping or delivery.

In block 304, the computing device receives a request from the merchant server to authenticate the user account. The computing device can forward the request to the contactless card. The request includes a query from the merchant server to determine an authentication method by which the contactless card associated with the user account will authenticate the user account.

In block 306, the computing device receives from the contactless card the response to the query. The response indicates the authentication method to be used by the contactless card. The response to the query can indicate that the authentication method to be used by the contactless card will be a fast identity online (FIDO) authentication method. The computing device can determine the authentication method using sequential selection of AID.

In block 308, the computing device sends the response indicating the authentication method to a node in a switching network to extract information from the response and use the extracted information to determine the issuer server associated with the contactless card. Forwarding the response indicating the authentication method to the node in the switching network can include forwarding a user account identifier with the response, wherein the node in the switching network is to use the information extracted from the response with the user account identifier to query a database to determine the issuer server associated with the contactless card.

In block 310, the computing device forwards an authentication request based on the indicated authentication method from the node in the switching network to the contactless card. The authentication request can include a FIDO authentication challenge.

In block 312, the computing device forwards from the contactless card an authentication response to the node in the switching network, wherein the node is to initiate authentication of the authentication response with the issuer server. The authentication response can include a signed FIDO response using a FIDO private key. Authenticating the authentication response can include authenticating the signed FIDO response.

In block 314, the computing device processes a transaction with the merchant server, whereby the transaction is processed using the personal data that was sent from the node in the switching network to the merchant server as a result of the authentication by the node. The method 300 can further include the computing device retrieves protocol information about the contactless card using a FIDO client to authenticator protocol (CTAP) communication between the computing device and the contactless card. Retrieving the protocol information can include determining the protocol information from the signed FIDO response and the authenticator attestation global unique identifier (AAGUID) of the contactless card. The information extracted from the response can include either or both of the protocol information from the signed FIDO response or the AAGUID.

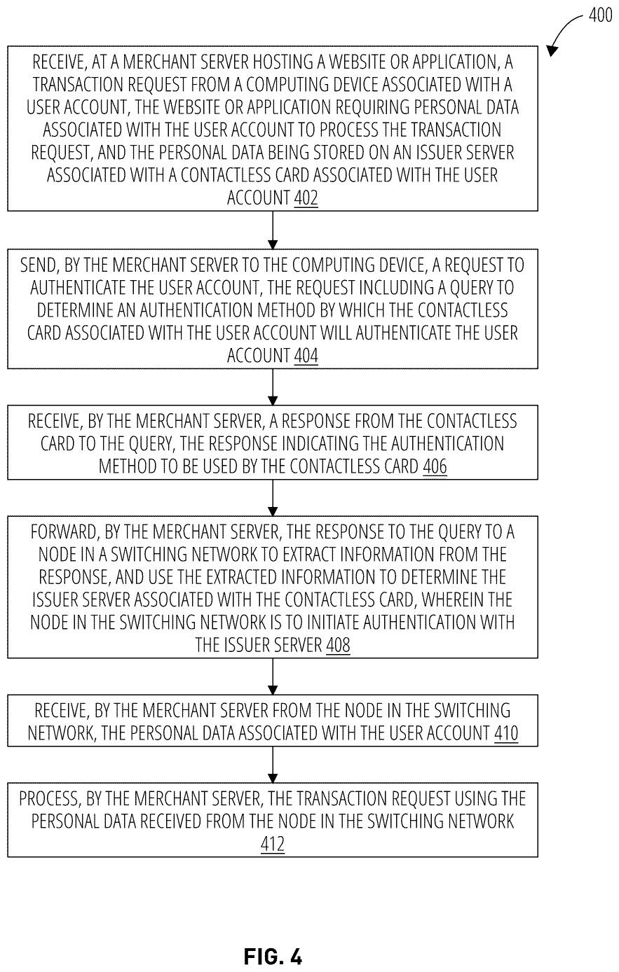

FIG. 4 is a flow chart of an example method 1400 for routing authentication conducted by a merchant server. In block 402, a merchant server hosting a website or application receives a transaction request from a computing device associated with a user account. The website or application requires personal data associated with the user account to process the transaction request, and the personal data is stored on an issuer server associated with a contactless card associated with the user account. The personal data can include at least payment credentials and personal information of the user account for shipping or delivery.

In block 404, the merchant server sends to the computing device, a request to authenticate the user account. The request includes a query to determine an authentication method by which the contactless card associated with the user account will authenticate the user account. A client software development kit (SDK) of the merchant server can generate and send the request, including the query, to the computing device to be forwarded to the contactless card.

In block 406, the merchant server receives a response from the contactless card to the query, the response indicating the authentication method to be used by the contactless card. The merchant server can receive protocol information about the contactless card retrieved by a computing device using a FIDO client to authenticator protocol (CTAP) communication between the computing device and the contactless card. Retrieving the protocol information can include determining the protocol information from the signed FIDO response and the authenticator attestation global unique identifier (AAGUID) of the contactless card.

In block 408, the merchant server forwards the response to the query to a node in a switching network to extract information from the response and use the extracted information to determine the issuer server associated with the contactless card. The node in the switching network is to initiate authentication with the issuer server. In some embodiments, a client SDK receives the response from the contactless card and forwards the response to the node in the switching network. The response to the query can indicate that the authentication method to be used by the contactless card will be a fast identity online (FIDO) authentication method, and the merchant server can forward a private FIDO key from the contactless card to the node in the switching network to perform FIDO authentication. The merchant server can forward a user account identifier with the response, wherein the node in the switching network is to use the information extracted from the response with the user account identifier to query a database to determine the issuer server associated with the contactless card.

In block 410, the merchant server receives, from the node in the switching network, the personal data associated with the user account. The personal data can include data indicative of, for example, government-issued identification such as a driver's license or passport, social security number, birth certificate, or any data that uniquely identifies the user.

In block 412, the merchant server processes the transaction request using the personal data received from the node in the switching network.

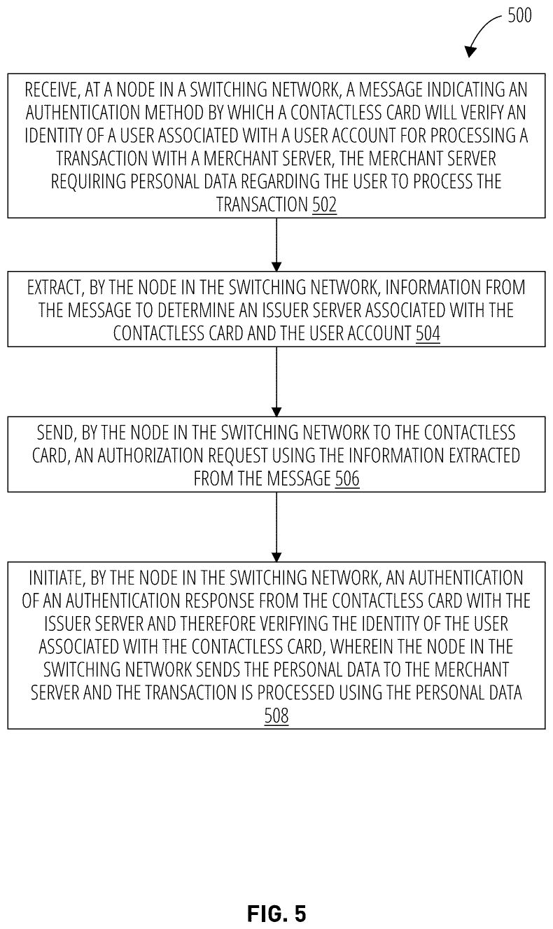

FIG. 5 is a flow chart of an example method 1500 for routing authentication conducted by a switching network. In block 502, a node in a switching network receives a message indicating an authentication method by which a contactless card will verify an identity of a user associated with a user account for processing a transaction with a merchant server. The merchant server requires personal data regarding the user to process the transaction. The node can receive the message from a client SDK on a client device. In other embodiments, the node can receive the message from the merchant server. The message can indicate that the authentication method to be used by the contactless card will be a fast identity online (FIDO) authentication method.

In block 504, the node in the switching network extracts information from the message to determine an issuer server associated with the contactless card and the user account. The extracted information can include a signed certificate of authentication and/or the AAGUID of the authenticator, which the node can use to identify the issuer server.

In block 506, the node in the switching network sends to the contactless card an authorization request using the information extracted from the message. The authentication request can include a FIDO authentication challenge.

In block 508, the node in the switching network initiates an authentication of an authentication response from the contactless card with the issuer server and therefore verifies the identity of the user associated with the contactless card. The authentication response can include a signed FIDO response using a FIDO private key and the authentication of the authentication response can include the issuer server authenticating the signed FIDO response. The node can identify a merchant identification associated with the merchant server. The node can by looking up in a database or table the merchant identification associated with the FIDO passkey held by the user. The node can then identify a FIDO key associated with the merchant identification. The issuer server can verify the authentication response using the FIDO key associated with the merchant identification. After authentication, the node in the switching network can retrieve the personal data from the issuer server and send the personal data to the merchant server to process the transaction using the personal data. The node can further generate, using the personal data and the signed FIDO response, an authorization token to process future transaction requests, the authorization token including an indication that the FIDO private key has already been verified for the user account, and verification of the FIDO private key is not needed for future transactions to be processed. The authorization token can expire when a session between a client device associated with the user and the node ends.

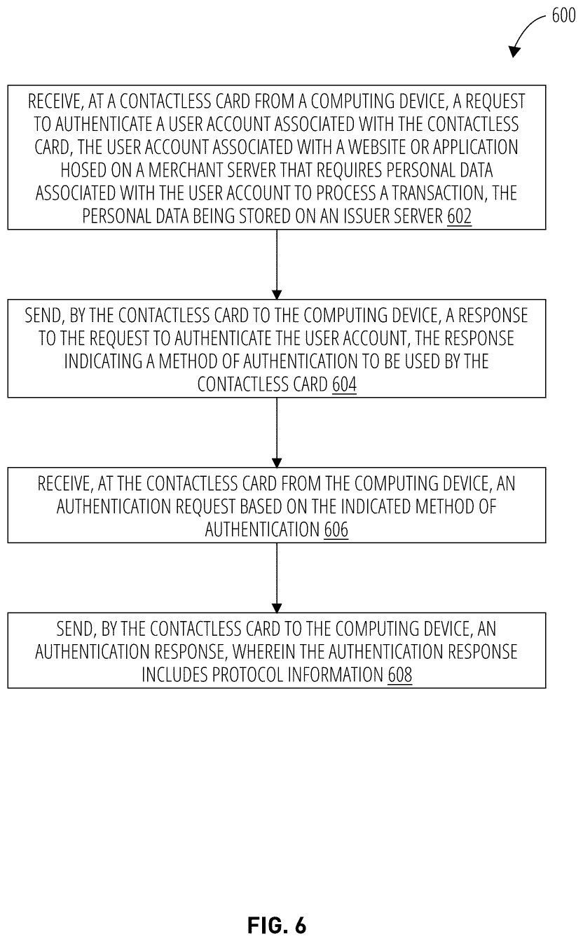

FIG. 6 is a flow chart of an example method 1600 for routing authentication conducted by a contactless card. In block 602, a contactless card receives from a computing device a request to authenticate a user account associated with the contactless card. The user account is associated with a website or application hosted on a merchant server that requires personal data associated with the user account to process a transaction. The personal data is stored on an issuer server.

In block 604, the contactless card sends to the computing device a response to the request to authenticate the user account, the response indicating a method of authentication to be used by the contactless card. In examples where the contactless card is configured for multiple authentication methods, the contactless card can have a pre-selected or default authentication method. The method of authentication to be used can be indicated by a flag or field in the response identifying the authentication to be used. In some embodiments, the client device can determine the authentication method by sequentially selecting an AID to query the contactless card until a search returns a found AID. The computing device can determine the selected authentication method by matching the format of one or more field values filled by the contactless card 102 in the response to the applet that uses the same format. The indicated method of authentication can be a fast identity online (FIDO) authentication method. In some embodiments, the response can include an identifier of the issuer server.

In block 606, the contactless card receives from the computing device, an authentication request based on the indicated method of authentication. If the indicated method is a FIDO authentication, then the request can include a FIDO authentication challenge.

In block 608, the contactless card sends to the computing device an authentication response, wherein the authentication response includes protocol information. The contactless card can communicate with the computing device using a FIDO client to authenticator protocol (CTAP) communication and the protocol information can include a signed FIDO response using a FIDO private key and an authenticator attestation global unique identifier (AAGUID) of the contactless card. The communication between the contactless card and the computing device can be conducted via an SDK executed on the computing device.

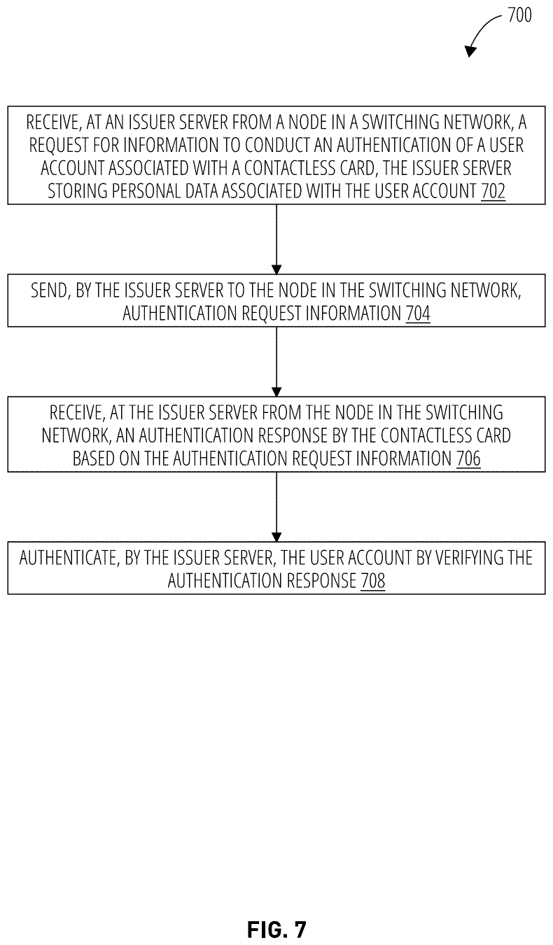

FIG. 7 is a flow chart of an example method 1700 for routing authentication conducted by an issuer server. In block 702, an issuer server receives from a node in a switching network a request for information to conduct an authentication of a user account associated with a contactless card. The issuer server stores personal data associated with the user account. The request for information can include an indication of a selected method of authentication. The indicated method of authentication can be a fast identity online (FIDO) authentication method.

In block 704, the issuer server sends to the node in the switching network authentication request information. The authentication request information can include a FIDO authentication challenge.

In block 706, the issuer server receives from the node in the switching network an authentication response by the contactless card based on the authentication request information. The authentication response can include a signed FIDO response, which is signed using a FIDO private key.

In block 708, the issuer server authenticates the user account by verifying the authentication response. The issuer server can receive additional information from the node in the switching network to conduct the authentication, such as a merchant identification of a merchant associated with the merchant server. The issuer server can receive from the node in the switching network an identifier of a public FIDO key associated with the merchant identification. The issuer server can verify the authentication response using the public FIDO key associated with the merchant identification. After verification, the issuer can send to the node in the switching network the stored personal data, which the node can forward to the merchant server for verification of the user account and to conduct a transaction.

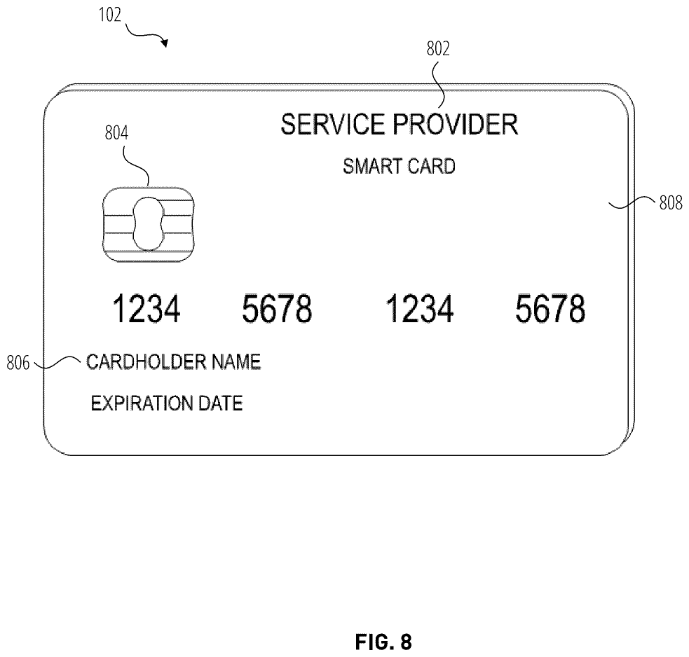

FIG. 8 illustrates an example configuration of a contactless card 102, which may include a contactless card, a payment card, such as a credit card, debit card, or gift card, issued by a service provider as displayed as service provider indicia 802 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 808, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102 according to the present disclosure may have different characteristics, and the present disclosure does not require a transaction card to be implemented in a payment card.

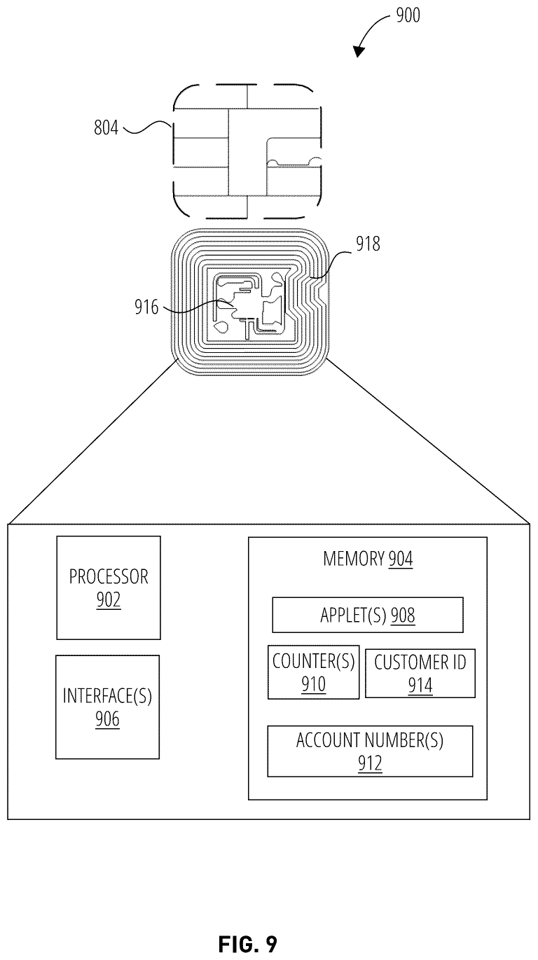

The contactless card 102 may also include identification information 806 displayed on the front and/or back of the card, and a contact pad 804. The contact pad 804 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna and other components as will be further discussed in FIG. 9. These components may be located behind the contact pad 804 or elsewhere on the substrate 808, e.g. within a different layer of the substrate 808, and may electrically and physically coupled with the contact pad 804. The contactless card 102 may also include a magnetic strip or tape, which may be located on the back of the card (not shown in FIG. 8). The contactless card 102 may also include a Near-Field Communication (NFC) device coupled with an antenna capable of communicating via the NFC protocol. Embodiments are not limited in this manner.

FIG. 9 illustrates the contact pad 804 of the contactless card 102, shown in FIG. 8. The contact pad 804 may include processing circuitry 916 for storing, processing, and communicating information, including a processor 902, a memory 904, and one or more interface(s) 906. It is understood that the processing circuitry 916 may contain additional components, including processors, memories, error and parity/CRC checkers, data encoders, anticollision algorithms, controllers, command decoders, security primitives and tamperproofing hardware, as necessary to perform the functions described herein.

The memory 904 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 904 may be encrypted memory utilizing an encryption algorithm executed by the processor 902 to encrypted data.

The memory 904 may be configured to store one or more applet(s) 908, one or more counter(s) 910, a customer identifier 914, and the account number(s) 912, which may be virtual account numbers. The one or more applet(s) 908 may comprise one or more software applications configured to execute on one or more contactless cards, such as a Java® Card applet. However, it is understood that applet(s) 908 are not limited to Java Card applets, and instead may be any software application operable on contactless cards or other devices having limited memory. The one or more counter(s) 910 may comprise a numeric counter sufficient to store an integer. The customer identifier 914 may comprise a unique alphanumeric identifier assigned to a user of the contactless card 102, and the identifier may distinguish the user of the contactless card from other contactless card users. In some examples, the customer identifier 914 may identify both a customer and an account assigned to that customer and may further identify the contactless card 102 associated with the customer's account. As stated, the account number(s) 912 may include thousands of one-time use virtual account numbers associated with the contactless card 102. An applet(s) 908 of the contactless card 102 may be configured to manage the account number(s) 912 (e.g., to select an account number(s) 912, mark the selected account number(s) 912 as used, and transmit the account number(s) 912 to a mobile device or a client device 104 for autofilling by an autofilling service.

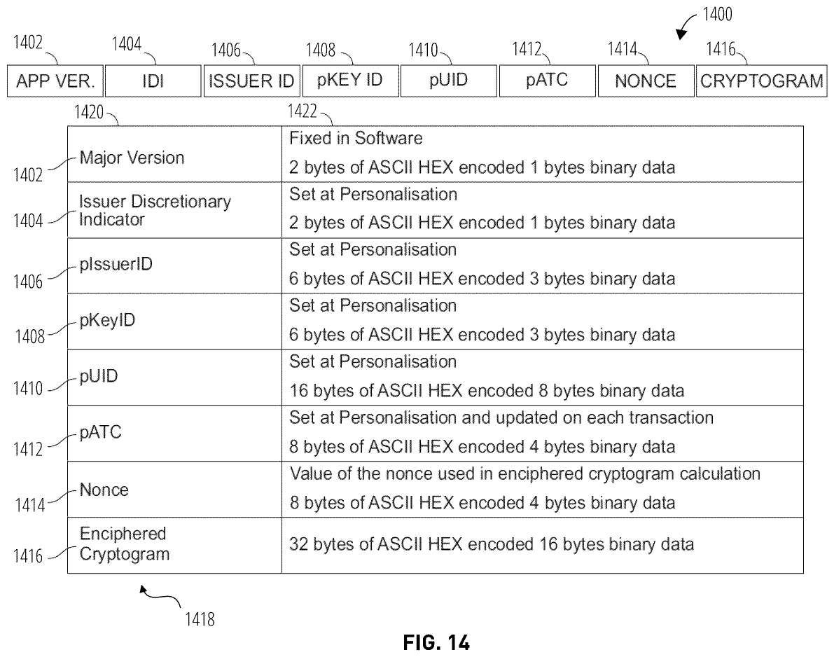

In some embodiments, the memory 904 can include (e.g., have stored therein) the data from the fields shown in FIG. 9 and/or FIG. 14. The processor 902 can then use the data from the fields to generate the message 1400 as described above.

The processor 902 and memory elements of the foregoing exemplary embodiments are described with reference to the contact pad 804, but the present disclosure is not limited thereto. It is understood that these elements may be implemented outside of the contact pad 804 or entirely separate from it, or as further elements in addition to processor 902 and memory 904 elements located within the contact pad 804.

In some examples, the contactless card 102 may comprise one or more antenna(s) 918. The one or more antenna(s) 918 may be placed within the contactless card 102 and around the processing circuitry 916 of the contact pad 804. For example, the one or more antenna(s) 918 may be integral with the processing circuitry 916 and the one or more antenna(s) 918 may be used with an external booster coil. As another example, the one or more antenna(s) 918 may be external to the contact pad 804 and the processing circuitry 916.

In an embodiment, the coil of contactless card 102 may act as the secondary of an air core transformer. The terminal may communicate with the contactless card 102 by cutting power or amplitude modulation. The contactless card 102 may infer the data transmitted from the terminal using the gaps in the contactless card's power connection, which may be functionally maintained through one or more capacitors. The contactless card 102 may communicate back by switching a load on the contactless card's coil or load modulation. Load modulation may be detected in the terminal's coil through interference. More generally, using the antenna(s) 918, processor 902, and/or the memory 904, the contactless card 102 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet(s) 908 may be added to contactless cards to provide a one-time password (OTP) for multifactor authentication (MFA) in various mobile application-based use cases. Applet(s) 908 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 908 may be configured to encode the OTP as an NDEF type 4 well known type text tag. In some examples, NDEF messages may comprise one or more records. The applet(s) 908 may be configured to add one or more static tag records in addition to the OTP record.

In some examples, the one or more applet(s) 908 may be configured to emulate an RFID tag. The RFID tag may include one or more polymorphic tags. In some examples, each time the tag is read, different cryptographic data is presented that may indicate the authenticity of the contactless card. Based on the one or more applet(s) 908, an NFC read of the tag may be processed, the data may be transmitted to a server, such as the application server 106 or a server in a node of the switchboard network 108 shown in FIG. 1, and the data may be validated at the server.

In some examples, the contactless card 102 and server may include certain data such that the card may be properly identified. The contactless card 102 may include one or more unique identifiers (not pictured). Each time a read operation takes place, the counter(s) 910 may be configured to increment. In some examples, each time data from the contactless card 102 is read (e.g., by a mobile device), the counter(s) 910 is transmitted to the server for validation and determines whether the counter(s) 910 are equal (as part of the validation) to a counter of the server.

The one or more counter(s) 910 may be configured to prevent a replay attack. For example, if a cryptogram has been obtained and replayed, that cryptogram is immediately rejected if the counter(s) 910 has been read or used or otherwise passed over. If the counter(s) 910 has not been used, it may be replayed. In some examples, the counter that is incremented on the card is different from the counter that is incremented for transactions. The contactless card 102 is unable to determine the application transaction counter(s) 910 since there is no communication between applet(s) 908 on the contactless card 102.

In some examples, the counter(s) 910 may get out of sync. In some examples, to account for accidental reads that initiate transactions, such as reading at an angle, the counter(s) 910 may increment but the application does not process the counter(s) 910. In some examples, when the client device 104 is woken up, NFC may be enabled and the client device 104 may be configured to read available tags, but no action is taken responsive to the reads.

To keep the counter(s) 910 in sync, an application, such as a background application, may be executed that would be configured to detect when the mobile client device 104 wakes up and synchronize with the server of a banking system indicating that a read that occurred due to detection to then move the counter(s) 910 forward. In other examples, Hashed One Time Password may be utilized such that a window of mis-synchronization may be accepted. For example, if within a threshold of 10, the counter(s) 910 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 910 increases in the appropriate sequence, then it possible to know that the user has done so.

The key diversification technique described herein with reference to the counter(s) 910, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple DES(3DES) algorithm may be used by EMV and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 102 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

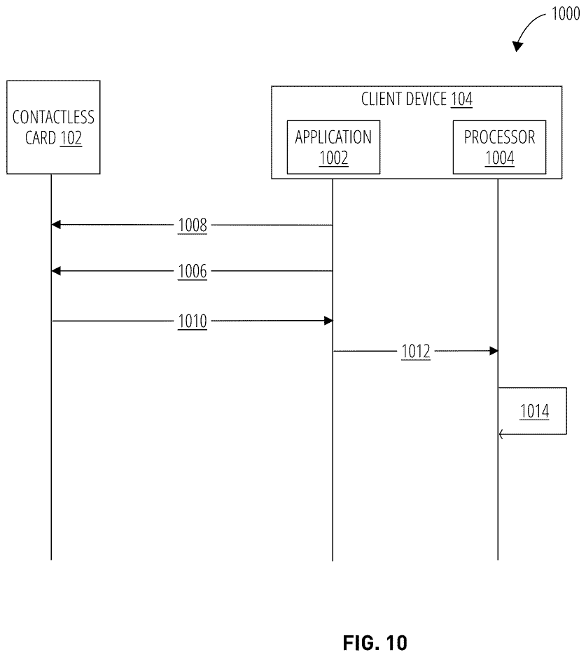

FIG. 10 is a timing diagram illustrating an example sequence for providing authenticated access according to one or more embodiments of the present disclosure. Sequence flow 1000 may include contactless card 102 and client device 104, which may include an application 1002 and processor 1004.

At line 1008, the application 1002 communicates with the contactless card 102 (e.g., after being brought near the contactless card 102). Communication between the application 1002 and the contactless card 102 may involve the contactless card 102 being sufficiently close to a card reader (not shown) of the client device 104 to enable NFC data transfer between the application 1002 and the contactless card 102.

At line 1006, after communication has been established between client device 104 and contactless card 102, contactless card 102 generates a message authentication code (MAC) cryptogram. In some examples, this may occur when the contactless card 102 is read by the application 1002. In particular, this may occur upon a read, such as an NFC read, of a near field data exchange (NDEF) tag, which may be created in accordance with the NFC Data Exchange Format. For example, a reader application, such as application 1002, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 1002 may be configured to transmit a request to contactless card 102, the request comprising an instruction to generate a MAC cryptogram.

At line 1010, the contactless card 102 sends the MAC cryptogram to the application 1002. In some examples, the transmission of the MAC cryptogram occurs via NFC, however, the present disclosure is not limited thereto. In other examples, this communication may occur via Bluetooth, Wi-Fi, or other means of wireless data communication. At line 1012, the application 1002 communicates the MAC cryptogram to the processor 1004.

At line 1014, the processor 1004 verifies the MAC cryptogram pursuant to an instruction from the application 1002. For example, the MAC cryptogram may be verified, as explained below. In some examples, verifying the MAC cryptogram may be performed by a device other than client device 104, such as a server of a banking system in data communication with the client device 104. For example, processor 1004 may output the MAC cryptogram for transmission to the server of the banking system, which may verify the MAC cryptogram, or the switchboard network as described herein, which may initiate the verification of the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

FIG. 11 illustrates an example of system 1100 in accordance with the embodiments discussed herein. The system 1100 includes additional devices and systems configured to enable contactless card issuers to tap-to-card services. Specifically, system 1100 enables any number of issuer systems to provide card services to their client devices through a switching fabric, i.e., the switchboard network 108 in a secure and safe manner.

In embodiments, the switchboard network 108 includes one or more nodes 1104 configured to perform routing operations. Each switchboard node 1104 may include a session and nonce generator 1106, a message router 1108, an authentication 1110, an operation data 1112 store, and a metrics store 1114. Further, each of the nodes may be configured the same and share configurations, but each switchboard node 1104 may independently process and route messages and requests to the appropriate systems, such as the merchant systems and issuer systems. Each of the nodes 1104 is configured to act as a broker of trust between an issuer system, the merchant system 1122, and/or validation system 1124, for example. Each switchboard node 1104 is configured to route each message to the correct issuer system while maintaining data security. For example, a switchboard node 1104 may route a message between an issuer system and a merchant system while the node cannot access the private data in the message.

The switchboard network 108 may be configured as a server system with a collection of hardware, software, and networking components that work together to provide client device services. Hardware components may include one or more server computers, storage devices, and network adapters. The server computers are configured to run server applications, such as those executable on each of the nodes 1104. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

In some embodiments, the nodes 1104 may operate in a cloud-based computing environment, e.g., a collection of hardware, software, and networking components that enable the delivery of cloud computing services. The switchboard nodes 1104 and the computing services are delivered over the Internet and can be accessed from anywhere in the world with an Internet connection. In embodiments, client device 104 may access a switchboard node 1104 through DNS 1102 or Domain Name System (DNS). The DNS 1102 is a hierarchical and distributed naming system for computers, services, and other resources connected to the Internet or other networks. It associates various information with domain names assigned to each registered participant. In one example, the DNS 1102 may translate a name known to software executing on a client device 104 to route data to one or more of switchboard node 1104 of the switchboard system. In embodiments, the DNS 1102 may generate a number, such as an Internet Protocol (IP) address, an address record (A-record), or another Hostname (C-name record). FIG. 12 illustrates one example sequence 1200 for a client device to identify and resolve an identifier for one of the nodes 1104 of the switchboard system. At a high level, the DNS 1102 translates known domain names to numerical Internet Protocol (IP) addresses needed for locating and identifying computer services and devices with the underlying network protocols. Clients use the global DNS system to select the best node to use, as discussed in sequence 1200.

In embodiments, a client device 104 communicates with the switchboard network 108 to perform one or more of the partner services 1132, such as conducting a transaction with a merchant, validating the customer, or other tap-to functions. Once client device 104 identifies a switchboard node 1104 and resolves an address to communicate with switchboard node 1104, client device 104 may send one or more messages to switchboard node 1104 to authenticate and perform the operation. The switchboard node 1104 includes an authentication 1110 function that is configured to authenticate the client device 104. In embodiments, the client device 104 sends a message or authorization request to the switchboard node 1104 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where Table 1 describes the value, name, and meaning:

TABLE 1

| Value | Name | Meaning |
|---|---|---|
| 65535 | Client | Individual |
| | ID | identifier of client |
| GReyx5BuEAaE72bWbFZJfHRL8Dbt1Uum | Client | Randomly |
| | Key | assigned key |

The switchboard node 1104 may authorize or authenticate the client device 104 or user, and the switchboard node 1104 may utilize the additional components, such as the session and nonce session and node generator 1106 and message router 1108, to perform the operations. Note the validation systems 1124 never interact with the merchant systems 1122, nor vice versa. The nodes 1104 broker all communication.

In embodiments, the switchboard network 108 may utilize a hyper ledger fabric 1120 to manage to synchronize the shared operation data 1112 and member management across the network. The hyperledger fabric 1120 is a distributed ledger framework having a permissioned network model in which only authorized participants can join the network and access the data that is stored on a ledger.

In embodiments, the hyperledger fabric 1120 may be generated by creating one or more sets of peers, an ordering service, and a channel. Once the network is created, system 1100 deploys chaincode to the network, or node 1104 is permitted to access the fabric. The chaincode is the code that runs on the blockchain and executes the network control 1126 and operation data 1112 logic code. Once the chaincode is deployed, each of the switchboard nodes 1104 is configured to invoke transactions on the blockchain to add data to the blockchain, e.g., the operational data. A switchboard node 1104 or another device can query the ledger to retrieve data. The ledger is a distributed database that stores all the data added to the blockchain.

All nodes 1104 keep an independently verifiable log of their actions that can be transmitted to a centralized aggregator to build a picture of overall network usage. System 1100 can manage network operation data and management at a central level and have a centralized view of network use, aggregated and abstracted to the appropriate level.

FIG. 12 illustrates an example sequence 1200 for a client device to utilize DNS to resolve and communicate with one or more nodes of a switchboard network 108. The illustrated sequence 1200 includes a client device 104, a DNS 1102, and a switchboard node 1104. At 1202, the sequence 1202 includes the client device 104 sending a request to a default DNS server for a text record switchboard.{domain}.{tld}. The text record may be preconfigured in a client app and/or client SDK. At 1204, the DNS 1102 returns one or more records. A DNS record structure may include the following:
Root Record:
   Name: switchboard.{domain}.{tld}
   Type: TXT
   Resolution:
      “{nodename_1}.{operator_a}.{region_i}.switchboard.{domain}.{tld},
      {nodename_2}.{operator_a}.{region_i}.switchboard.{domain}.{tld},”
      {nodename_1}.{operator_b}.{region_ii}.switchboard.{domain}.{tld},
      {nodename_2}.{operator_b}.{region_ii}.switchboard.{domain}.{tld},
      * etc.
   Used For determining where there are active nodes
Node Record:
   Name: {nodename}.{operator}.{region}.switchboard.{domain}.{tld}
   Type: A/AAAA or CNAME
   Resolution: Actual node hostname or IP
   Used For: communicating with a node 1104

In embodiments, the client device 104 may determine the current timezone at 1206. For example, the client app or SDK may utilize a get current timezone function, such as in JavaScript: Intl.DateTimeFormat( ).resolvedOptions( ).timeZone). Embodiments are not limited in this manner, and the app or sdk may determine the timezone via another/different function call. At 1208, the client device 104 is configured to map the timezone to a region or short-version identifier of the region. One example includes America/New_York->na-e. The region may be based on DNS names, for example. Table 2 illustrates a few examples of timezone mappings to regions:

TABLE 2

| Timezone | Region | Short Version |
|---|---|---|
| America/New_York | North America/East | na-e |
| America/Buenos_Aires | South America | sa |
| US/Pacific | North America/West | na-w |
| Europe/Paris | Europe | eu |

Embodiments are not limited to these examples, and other timezone-to-region mappings may be utilized. Further and in embodiments, Regions can also be represented as a bidirectional graph structure with the edges representing geographic neighbors. For example, na-e<->na-w and sa<->na-w and sa<->na-e. This representation is useful for node selection.

At 1210, the client device 104 may identify or select a DNS record option returned at 1204 that is in the region. If there are multiple matches, the client device 104 may select one at random. If there's no node available in a region, the client device 104 may determine and use a data graph of neighboring regions to select a node in the closest region where a node is available at 1212. For example, sa has no node but is connected to na-e where there is a node and so na-e is selected. In some embodiments,

At 1214, the client device may resolve a selected node's hostname. In embodiments, the client device 104 may automatically resolve the hostname using the client's HTTP request default resolver. At 1216, the DNS 1102 may return a result. And at 1218, the client device 104 may communicate with a switchboard node 1104 and begin the process to interact with the switchboard.

FIG. 13A-FIG. 13C illustrate an example sequence 1300 to perform operations between a contactless card 102 and services provided by a card issuer and/or merchant. The illustrated sequence 1300 includes actions and communications performed by a contactless card 102, a client device 104 including a client app 1390 and a client SDK 1392, a DNS 1386, a switchboard system including one or more nodes 1104, a partner services 1132 including a merchant and/or validator 1388, and control services 1134 including a client server 1384 or system. In embodiments, the client app 1390 may be any application configured to execute on a client device 104, such as a banking app, a merchant app, a social media app, a travel app, a gaming app, a productivity app, an entertainment app, and so forth. In embodiments, the client app 1390 includes a web browser to provide websites and pages. The client app 1390 may include and/or utilize the client SDK 1392, which may be a set of instructions that enable the client app 1390 to communicate with other components of the switchboard system.

In embodiments, as shown in FIG. 13A, at 1302 the client device 104 including the client app may send a request and establish a session with a client server 1384 such that a result may be associated with the correct client device or user. The request establishes a relationship between the client device 104 and client server 1384, which may be the issuer server 112 shown in FIG. 1. At 1304, the client server 1384 generates a session and CLIENT SESSION INFORMATION. At 1306, the client server 1384 returns the session information, e.g., the CLIENT SESSION INFORMATION. In embodiments, the CLIENT SESSION INFORMATION may be the Client implementation-specific user session identification information. In examples where the selected authentication method does not readily indicate the identity of the issuer server 112, such as the FIDO2 authentication method, steps 1302 through 1306 may be skipped.

At 1308, the client device 104 may initiate a contactless card authentication process with the client device 104. For example, the client device 104 may call a function and/or pass information to the client device 104 to initiate authentication via the contactless card 102. The client device 104 may initiate the authentication process based on a request for authentication from a relying party website or application running o the client device 104, which can include an inquiry about the intended authentication method to be used. The client device 104 response in step 1308 can be directed to the client SDK 1392 on the client device 104 and include an indication of the intended authentication method to be used. At 1310-1314, the client device 104 may utilize DNS to identify a node and establish communication with the node. Specifically, at 1310, the client device 104 including the client SDK 1392 may send a request for switchboard hostnames, and at 1312 the DNS 1386 may return information including one or more hostnames. At 1314, the client device 104 may determine a switchboard node to communicate. FIG. 12 illustrates an example of a more detailed sequence of the process to establish communication with a switchboard node 1104.

At 1316, the client SDK 1392 may send a request for a session to the switchboard network 108. In embodiments, the request for a session may be for a function request in the format <FUNCTION REQUEST>. In embodiments, the FUNCTION REQUEST may be the data/function that the client device 104 would like to request once a contactless card 102 has been validated. The function could be for any service discussed herein, e.g., authenticate the user, provide user identification stored during a FIDO2 registration, perform a transaction, request autofill data, etc. At 1318, switchboard system 1100 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card 102. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>, <CLIENT SESSION INFO>, and <FUNCTION REQUEST> signed with <NODE PRIVATE KEY>, where the NODE PRIVATE KEY is the switchboard system 1100 private key. The switchboard system 1100 may include a NODE PUBLIC/PRIVATE KEY, which is a keypair used to sign and validate JWTs.

At 1320, the switchboard system 1100 may return session information to the client device 104. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 1322, the client SDK 1392 may determine and/or receive user consent to the terms of service. In one example, the client SDK 1392 captures and records the user consent to <FUNCTION TOS> on <CONSENT DATE> with <TOS VERSION>. The CONSENT DATE may be the timestamp for the user's consent to the TOS.

At 1324, the client device 104 exchanges one or more messages with the contactless card 102. In one example, the exchange may be based on the contactless card 102 being tapped to the client device 104. The client SDK 1392 may prompt a user to tap the contactless card 102 to the client device 104 in response to an authentication request, such as a FIDO challenge if a FIDO2 authentication is being conducted, and the tap and read at 1324 can include the contactless card 102 sending an authentication response, such as a signed FIDO challenge. In embodiments, the client SDK 1392 may provide data to the contactless card 102 to use during the session to perform the function. The data may be provided to the contactless card 102 in an NDEF message. In one example, the data is written to the contactless card 102 in NDEF format using a binary update command. The data may include a NONCE to provide a level of security that the message received from the card is part of the same session. Additionally, the data may include additional information, such as one or more control bits to control the format generated by the contactless card. Table 3 below illustrates an example of an NDEF message format.

TABLE 3

| Byte | Data Item | Value |
|---|---|---|
| 00 | NDEF Message | D1 (only record) |
| | Tag | |
| 01 | Length of Record | 01 |
| | Type | |
| 02 | Length of Record | 33 |
| 03 | text record type | 54 |
| 04 | Length of | 02 |
| | Language | |
| 05-06 | Language | 65 6E (“en”) |
| 07 . . . | NONCE | 8 bytes of ASCII HEX encoded 4 bytes |
| 0E | | binary data |
| 0F . . . | Session | 4 bytes of ASCII HEX encoded 2 bytes |
| 12 | Indicators | binary data |
| 13 . . . | Control | 4 bytes of ASCII HEX encoded 2 bytes |
| 16 | Indicators | binary data |
| 17 . . . | Update Date | 16 bytes of ASCII HEX encoded 8 bytes |
| 26 | creation Time | binary data - represents 64 bit unix |
| | | timestamp |
| 27 . . . | Update MAC | MAC to protect control indicators - 16 bytes |
| 36 | | of ASCII HEX encoded 8 bytes binary data |

The updated MAC may be calculated to protect the control indicators in embodiments. Specifically, The MAC M is determined by calculating a MAC over the 10 bytes of the update data U with the Update MAC Card Key (MCK), as described in FIG. 14, message 1400.

At 1324, the contactless card may generate and provide a message to the client's device including the client SDK 1392. The data in the message may be utilized by the system discussed herein to perform the function requested. One example of the message is illustrated and discussed in FIG. 14, message 1400.

At 1326, the client device including the client SDK 1392 may send a message and information to the switchboard system 1100. The message may be the message received from the contactless card 102, e.g., message 1400. In addition, the client SDK 1392 may send the consent date, the TOS version, and the signed session token to the switchboard system 1100. The switchboard system 1100 may utilize the information to ensure the session is valid. At 1328, the switchboard system 1100 verifies the signed session token is valid, e.g., is the previously provided signed session token and includes the nonce previously generated and is in the message.

In some embodiments, the switchboard system 1100 is configured to determine which issuer system or client server it should route the message to for processing. At 1330, the switchboard system 1100 may determine the issuer ID by extracting it from the message received from the contactless card 102 via the client SDK 1392. As mentioned, the issuer ID identifies the issuer of the contactless card 102.

FIG. 13B continues the sequence 1300 from FIG. 13A. In embodiments, the switchboard system 1100 is configured to generate and communicate secure communications with the issuer system, e.g., the client server 1384 and the validator 1388. At 1332, the switchboard system 1100 sends a request for a key to the client server 1384. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 1334, the client server 1384 generates a portion of the key. In some instances, the client server 1384 may generate half of the ECDH key for encryption/decryption of PII. Specifically, the client server 1384 may generate <CLIENT EC PUBLIC KEY> and <CLIENT EC PRIVATE KEY> using Elliptic Curve P256. The CLIENT EC PUBLIC KEY AND CLIENT EC PRIVATE KEY is the first half of the ECDH key negotiation.

At 1336, the client server 1384 stores the generated portion of the key in storage. Specifically, the client server 1384 may store <CLIENT EC PUBLIC KEY> and <CLIENT EC PRIVATE KEY> with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 1384 may return the public key portion to the switchboard system 1100 with the KEY ID at 1338. The switchboard system 1100 may store the public key portion with the KEY ID for later use, e.g., generation of the ECDH key. At 1340, the switchboard system 1100 may request a validation to be performed by the validator 1388. In one example, the switchboard system 1100 may send a request validation as Request validation <MESSAGE>, <SIGNED SESSION TOKEN>, <CLIENT EC PUBLIC KEY>, <CONSENT DATE>, and the <TOS VERSION>. The validator 1388 may make an out-of-band request back to the switchboard system 1100 for the public key to verify the session at 1342. At 1344, the switchboard system 1100 may provide the node's public key, i.e., <NODE PUBLIC KEY>. Further at 1346, the validator 1388 may utilize the node's public key to verify the secure session token.

In embodiments, the validator 1388 may validate the message at 1348. In embodiments, the validator 1388 may perform a number of validations including ensuring the nonce in the message is correct along with additional information, such as the card's unique identifier (pUID), and the counter value (pATC).

At 1350, the validator 1388 may store information associated with the session. For example, validator 1388 may store the <CONSENT DATE> with the <TOS VERSION> and the <PUID>. The validator 1388 may also generate another portion of the key, e.g., the ECDH key. For example, the 1388 may Generate <ISSUER EC PUBLIC KEY> and <ISSUER EC PRIVATE KEY> using Elliptic Curve P256. The ISSUER EC PUBLIC KEY and ISSUER EC PRIVATE KEY may be the second half of the ECDH key negotiation.

At 1354, the validator 1388 may generate the complete ECDH key. For example, the validator 1388 generates the <ECDH KEY> from <ISSUER EC PRIVATE KEY> and <CLIENT EC PUBLIC KEY>. The ECDH KEY is the final key generated using ECDH key negotiation.

The validator 1388 may utilize the ECDH KEY to encrypt data for the function. For example, if the validator 1388 validates the message in some instances, the validator 1388 may execute a function request to create a function result and encrypt the result with the ECDH KEY at 1356. For example, the validator 1388 may Execute <FUNCTION REQUEST> to create <FUNCTION RESULT> and encrypt it with the <ECDH KEY>. The function result may be any result based on the requested function, e.g., verification of the card.

At 1358, the validator 1388 may return the function result to the switchboard system 1100. In some instances, the function result is returned encrypted. For example, the validator 1388 may return the <ENCRYPTED FUNCTION RESULT> and the <ISSUER EC PUBLIC KEY>.

FIG. 13C continues the sequence 1300 from FIG. 13B. In embodiments, at 1360 the switchboard system 1100 sends the function result to the client server 1384 to process the result. In one example, the switchboard system 1100 may send the <ENCRYPTED FUNCTION RESULT>, <KEY ID>, <ISSUER EC PUBLIC KEY>, and <SIGNED SESSION TOKEN>. At 1362 and 1364, the client server 1384 may make a request for and receive the public key from the switchboard system 1100. In some instances, the exchange may be performed via out-of-band communication channels. The public key for the node may be <NODE PUBLIC KEY>. The public key may be used to verify the sender of the function result, etc. At 1366, the client server 1384 may verify the signed session key with the node's public key <NODE PUBLIC KEY> to verify the sender of the information. At 1368, the client server 1384 may extract client information from the signed session token. For example, the client server 1384 may Extract <CLIENT SESSION INFO> from <SIGNED SESSION TOKEN>, i.e., extracting the client implementation-specific user session identification information.

Further, at 1370, the client server 1384 may retrieve the client's private key with the KEY ID. Specifically, the client server 1384 may get and remove the <CLIENT PRIVATE KEY> from cache using the <KEY ID>. At 1372, the client server 1384 may generate or compute the ECDH key. For example, the client server 1384 may compute the <ECDH KEY> with the <CLIENT PRIVATE KEY>+<ISSUER EC PUBLIC KEY>. The client server 1384 may decrypt the function result with the computed key at 1374. Specifically, the client server 1384 may decrypt the <ENCRYPTED FUNCTION RESULT> with the <ECDH KEY> to determine the <FUNCTION RESULT>. At 1376, the client server 1384 associates the function result with the session.

In embodiments, the switchboard system 1108 may return whether the function result was successfully completed or not at 1378 to the client SDK 1392. Further at 1380, the client SDK 1392 may notify the client app 1390 of the result. At 1382, the client app 1390 may utilize the feature. For example, the client app 1390 may communicate with the client server 1384 to continue the feature using the <CLIENT SESSION INFO> to fetch the redacted <FUNCTION RESULT>.

FIG. 14 illustrates an example of a message 1400 that may be communicated by a contactless card to perform the functions described herein, such as those discussed in FIG. 13A through FIG. 13C. One or more of the fields in message 1400 may also be utilized to route the message 1400 through the switchboard system and perform authentication/validation techniques.

In embodiments, the message 1400 includes an applet version 1402 field, an issuer discretionary indicator 1404 field, an Issuer Identifier 1406 field, a pKey ID 1408 field, a pUID 1410 field, a pATC 1412 field, a nonce 1414 field, and an encrypted cryptogram 1416.

In embodiments, the fields may be in plain text or encrypted. For example, the applet version 1402 field may include an applet version in plain text. The applet version indicates which applet version is installed on a contactless card and may be used by the other systems to determine how to process the message 1400 when communicated. For example, different Applet versions require different validation logic, e.g., an older message may be routed through the issuer system to perform various operations for validation, while a newer message may be routed through the switchboard system to perform the various operations, including validation.

In embodiments, the message 1400 includes an issuer discretionary indicator 1404 field that may include issuer data and set at the time of personalization. In addition, the message 1400 includes an Issuer Identifier 1406 field that may include a unique ID assigned to the entity issuing the card, e.g., the issuer. For example, when joining the system, each issuer may be assigned a unique identifier during an onboarding operation. The issuer ID can be used by the switchboard system 1108 to route a message and its contents to the appropriate services that are associated with that particular issuer.

In embodiments, the message 1400 includes a pKey ID 1408 field. In some instances, the pKey ID 1408 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 102 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described herein.

The message 1400 may include a pUID 1410 field, including a card unique identifier assigned to the contactless card at personalization time. The pUID 1410 field data may be a combination of alphanumeric characters used to identify each card and associated with a user uniquely.

In embodiments, the message 1400 includes a pATC 1412 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 1400 is created, a new session key is derived and utilized to generate one or more portions of the message 1400. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 1400 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 102 may communicate a message between a device, such as a mobile device, during a read operation. For example, in response to the contactless card 102 being tapped onto a surface of the device, e.g., brought within wireless communication range, a read operation may be performed on the contactless card 102, and the contactless card 102 may generate and provide the message to the device. For example, once within range, the contactless card 102 and the device may perform one or more exchanges for the contactless card 102 to send the message to the device.

The wireless communication may be in accordance with a wireless protocol, such as near-field communication (NFC), Bluetooth, WiFi, and the like. In some instances, a message may be communicated between a contactless card 102 and a device via wired means, e.g., via the contact pad, and in accordance with the EMV protocol.

As discussed above, the contactless card 102 may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card 102. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc, may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card 102 stores the generated application key(s) or UDK(s).

In embodiments, the contactless card 102 utilizes the application key(s) or UDK(s) to generate session keys for each encrypted data is generated. The following is one processing flow that may be performed by the contactless to generate a unique cryptogram session key (ASK).

To generate the ASK, the contactless card 102 computes SKL by encrypting [ATC[2]∥ATC[3]∥‘F0’∥‘00’∥[ATC[0]∥[ATC[1]∥[ATC[2]∥[ATC[3]] with an application key. Further, the contactless card 102 computes SKR by encrypting [ATC[2]∥ATC[3]∥‘0F’∥‘00’∥[ATC[0]∥[ATC[1]∥[ATC[2]∥[ATC[3]] with the application key. Finally, the contactless card 102 concatenates SKL with SKR to form an authentication session key (ASK). In embodiments, the ASK is used to perform operations utilizing the contactless card 102, such as encrypting the cryptographic MAC.

In embodiments, the contactless card 102 also supports session key derivation to generate a unique encipherment session key DESK. The contactless card 102 computes an SKL by encrypting [ATC[2]∥ATC[3]∥‘F0’∥‘00’∥‘00’∥‘00’∥‘00’∥‘00’] with a Data Encryption Key (DEK) or UDK. Further, the contactless card 102 computes SKR by encrypting [ATC[2]∥ATC[3]∥‘0F’∥‘00’∥‘00’∥‘00’∥‘00’∥‘00’] with the DEK or UDK. The contactless card 102 concatenates SKL with SKR to form the Data Encipherment Session Key (DESK).

In embodiments, the contactless card 102 generates encrypted data or a cryptogram utilizing the session keys. Specifically, the contactless card 102 generates a cryptogram C by calculating a MAC over the 32-byte transaction data T using the Authentication Session Key (ASK).

The contactless card 102 may process the data to generate the cryptogram. Specifically, the contactless card 102 divides T into four blocks of 8 bytes of data: T=T1∥T2∥T3∥T4. The contactless card 102 computes B=DES(ASKL) [T1], where is the Data Encryption Standard or another symmetric encryption algorithm, ASKL is a portion of the ASK, e.g., the “left” half of the key. The contactless card 102 computes B=[B XOR T2], and, the contactless card 102 computes B=DES(ASKL) [B], where DES is an encryption algorithm. The contactless card 102 computes B=[B XOR T3], and the contactless card 102 computes B=DES(ASKL) [B]. The contactless card 102 computes B=[B XOR T4], and the contactless card 102 computes B=DES(ASKL) [B]. The contactless card 102 computes B=DES⁻¹(ASKR) [B], where DES⁻¹ is the reciprocal DES operation, and ASKR is a portion of the ASK, e.g., the right half. The contactless card 102 computes the cryptogram C=DES(ASKL) [B].

In embodiments, a contactless card 102 may also encipher the cryptogram to secure the data further. For example, a contactless card 102 may generate an 8-byte random number [RND] and the card computes E1=DES3(DESK) [RND], where DES3 is a symmetric encryption algorithm such as the Triple Data Encryption Standard. The contactless card 102 then computes B=[E1] XOR [C], where C is the cryptogram generated, as discussed above. The contactless card 102 computes E2=DES3(DESK) [B], where B is computed above. Further, the contactless card 102 generates the 16-byte enciphered payload E=[E1]∥[E2].

In embodiments, a device or the contactless card 102 may decrypt the payload E by determining, receiving, or retrieving the payload E. The device computes a RND=DES3⁻¹(DESK) [E1]. The device determines B=DES3⁻¹(DESK) [E2], and the device computes C=[E1] XOR [B].

In embodiments, the contactless generates or calculates a message authentication code (MAC). In some instances, the MAC may be an updated MAC. In embodiments, the updated MAC is included in data communicated from a contactless card 102 to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes)∥Update Date Time (8 bytes)∥‘80’∥‘00 00 00 00 00’]. For the calculations, the data may be divided into two separate portions. Specifically, the data U is broken into two blocks of 8 bytes of data, where U=U₁∥U₂. Further, operations may be performed on U₁ and U₂.

Embodiments include applying an algorithm to the first portion (U₁) of the data. In one example, a result B may be computed where B=DES(MCKL) [U₁], where DES is a Data Encryption Standard algorithm using a first portion (L) of the MAC Card Key (MCKL).

Further, an additional operation may be performed on the result B. Specifically, the result B may be exclusively or'd (XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

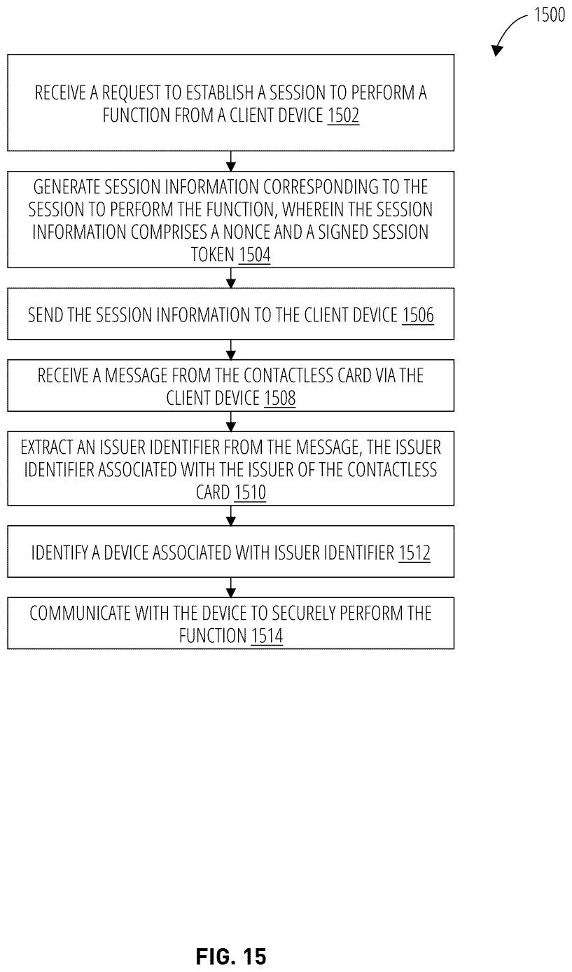

FIG. 15 illustrates an example of method 1500 in accordance with embodiments discussed herein. In block 1502, the method 1500 includes receiving, by a node in a system, a request to establish a session to perform a function from a client device, wherein the function is at least partially performed utilizing a contactless card, such as contactless card 102. In some instances, the node may be one of a plurality nodes of a switchboard system. The node may be previously selected by the sending device via a DNS operation performed.

In block 1504, the method 1500 includes generating, by the node, session information corresponding to the session to perform the function, wherein the session information comprises a nonce and a signed session token. The nonce and/or signed session token may be utilized by systems to perform the functions described herein while ensuring the node routing the data is authenticated, the message from the contactless card is authenticated, and to keep track of the session for the function.

In block 1506, method 1500 includes sending the session information to the client device by the node. The client device may communicate with a contactless card to receive data from the card to authenticate and perform a function. In some instances, the client device may send the nonce from the node to the contactless card. The contactless card may utilize the nonce when generating the message to communicate back to the client device. Finally, the node, e.g., incorporates it into a cryptographic portion of the message (see FIG. 14).

In block 1508, method 1500 includes receiving, by the node, a message from the contactless card via the client device. The message may be generated by the contactless card. FIG. 14 illustrates one example of a message 1400. In some embodiments, the node verifies the message. For example, the node may verify a nonce in the message and a signed session token.

In block 1510, method 1500 extracts an issuer identifier from the message by the node, the issuer identifier associated with the issuer of the contactless card. In some instances, the issuer identifier may be in a plaintext format.

In block 1512, method 1500 identifies, by the node, a device associated with the issuer identifier. For example, the node may perform a lookup to determine a server associated with the issuer identifier and the function to be performed.

In block 1514, method 1500 communicates, by the node, with the device to securely perform the function.

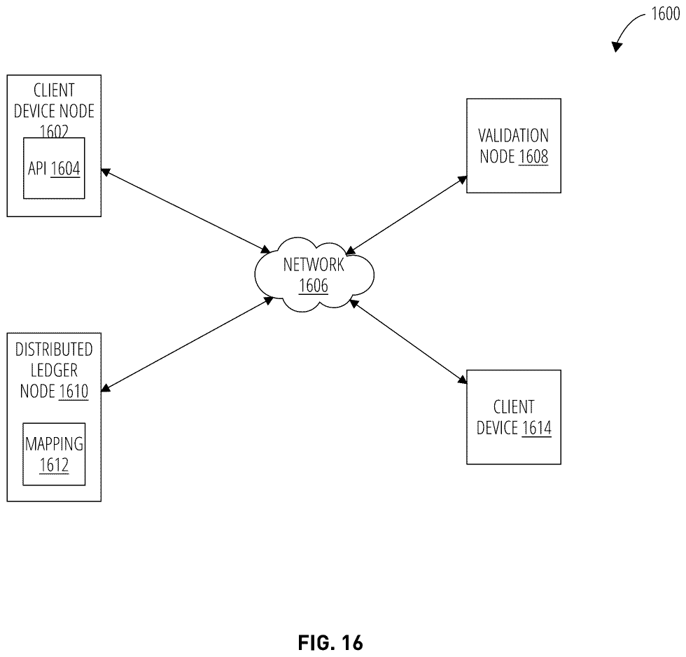

FIG. 16 illustrates a distributed network authentication system 1600 according to an example embodiment. As further discussed below, system 1600 can include client node 1602, API 1604, network 1606, distributed ledger node 1610, mapping 1612, and client device 1614. Although FIG. 16 illustrates single instances of the components, system 1600 can include any number of components.

System 1600 can include a client node 1602, which can be a network-enabled computer as described herein. In some examples, client node 1602 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1600.

In some examples, client node 1602 can execute one or more applications, such as software applications, that enable, for example, network communications with one or more components of system 1600, transmit and/or receive data, and perform the functions and processes described herein.

The client node can contain an API 1604. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 1604 to interact with the service, such as by performing a remote call to an API for interacting with a web-based service.

API 1604 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 1602 can communicate with one or more other components of system 1600 either directly or via network 1606. Network 1606 can comprise one or more of a wireless network, a wired network or any combination of wireless network and wired network, and may be configured to connect the components of system 1600. While FIG. 16 illustrates communication between the components of system 1600 through network 1606, it is understood that any component of system 1600 can communicate directly with another component of system 1600, e.g., without involving network 1606.

System 1600 can include a validation node 1608, which can be a network-enabled computer as described herein. In some examples, validation node 1608 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1600.

In some examples, validation node 1608 can execute one or more applications, such as software applications, that enable, for example, network communications with one or more components of system 1600, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1600 can include a distributed ledger node 1610, which can be a network-enabled computer as described herein. In some examples, distributed ledger node 1610 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1600.

In some examples, distributed ledger node 1610 can execute one or more applications, such as software applications, that enable, for example, network communications with one or more components of system 1600, transmit and/or receive data, and perform the functions and processes described herein.

Distributed ledger node 1610 can containing a mapping 1612. In some examples, mapping 1612 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1600, or the one or more databases can be hosted externally to any component of the system 1600. In some examples, the one or more databases can be contained in the distributed ledger node 1610, and in other examples the one or more databases can be stored outside of distributed edger node 1610 but in data communication with distributed ledger node 1610. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’;). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 1610. In other examples, the one or more databases can be remote from distributed ledger node 1610 but in data communication with distributed ledger node 1610. Data communication between the one or more databases and distributed ledger node 1610 can be a direct data communication or data communication via a network, such as the network 1606.

In some examples, client node 1602 can be in data communication with distributed ledger node 1610. Distributed ledger node 1610 can contain mapping 1612. Mapping 1614 may include, e.g., a mapping between a validation node address and the validation node 1608, a mapping between a routing number and a validation node address, and/or a mapping between a routing number and validation node 1608. In some examples, mapping 1612 can include a digital signature associated with an entity having permission to validate for a routing number. Based on one or more of these associations, client node 1602 can call validation node for validation and/or provide direction to the client device to reach the appropriate validation node. This can be accomplished by calling a validation API associated with validation node 1608.

In some examples, iterations of the mappings described herein, such as mapping 1612, can also include a software or applet version number. The version number can be used to identify a validation node or validation node address or choose between multiple validation addresses for one validation node.

In some examples, client node 1602 and distributed ledger node 1610 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 1610 can update mapping 1612 to reflect a different association between, e.g., a routing number, a validation node address, and a validation node. In some examples, degrees of permissions can be issued. For example, if client node 1602 were to function to route data to validation node 1608 (or other validation nodes), client node 1602 can be given a certain level of permissions. As another example, if distributed ledger node 1610 were to have the capability to update mapping 1612, distributed ledger node 1610 can have a different, higher level of permissions.

System 1600 can include a client device 1614, which can be a network-enabled computer as described herein. In some examples, distributed ledger node 1614 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1600. Client device 1614 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 1614 can be in data communication with another network-enabled computer not shown in FIG. 16, such as a smart card (e.g., a contactless card or a contact-based card).

In some examples, client device 1614 can execute one or more applications, such as software applications, that enable, for example, network communications with one or more components of system 1600, transmit and/or receive data, and perform the functions and processes described herein.

In some examples, upon receipt of an authentication request, client device 1614 can call (e.g., via an API) client node 1602. The call can include a routing number and/or an applet or software version number, and client node 1602 can query distributed ledger node 1610 and mapping 1612. Once the query returns the identification of a validation node (e.g., validation node 1608) and/or a validation node address associated with that routing number and/or applet or software version, client node 1602 can reply to client device 1614. Client device 1614 can then proceed with authentication with the validation node. The authentication can be performed by, e.g., the systems and methods described herein, such as by the generation, encryption, transmission, decryption, and validation of a cryptogram as described herein.

In some examples, client node 1602 can be co-resident with validation node 1608. In these examples, client node 1602 can handle the authentication in a single call from client device 1614. In some examples, this can be acceptable only if it is permissible for the full authentication transmission (e.g., a cryptogram as described herein) to be sent to client nodes that are not involved in authentication.

In some examples, if client node 1602 receives, from client device 1614, a routing number that is not handled by its location, client node 1602 can return a code indicating that this routing number is not handled, along with validation node address for the responsible validation node. Client device 1614 can then send the full authentication transmission to validation node 1608 using the received validation node address.

In some examples, client node 1602 can enter the distributed network with different permissions. For example, client node 1602 can be a read-only router of data. As another example, client node 1602 can have permission to send messages to distributed ledger node 1610 updating one or more routing paths for one or more routing numbers. However, client node 1602 would be prevented from updating one or more routing paths for one or more routing numbers for other entities that control other routing numbers which are not associated with client node 1602 or that did not grant this permission. As another example, distributed ledger node 1610 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client deice node 1602, distributed ledger node 1610, and/or validation node 1608, if security, legal, and/or financial conditions are met, however, delegation is not required.

In some examples, one or more APIs can facilitate communication between components of system 1600 via network 1606. In other examples, one or more APIs are not required. Rather, the components of system 1600 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 1608 for authentication, can require storage of the keys in one or more HSMs, to promote key security and ensure that the keys are never entered into memory.

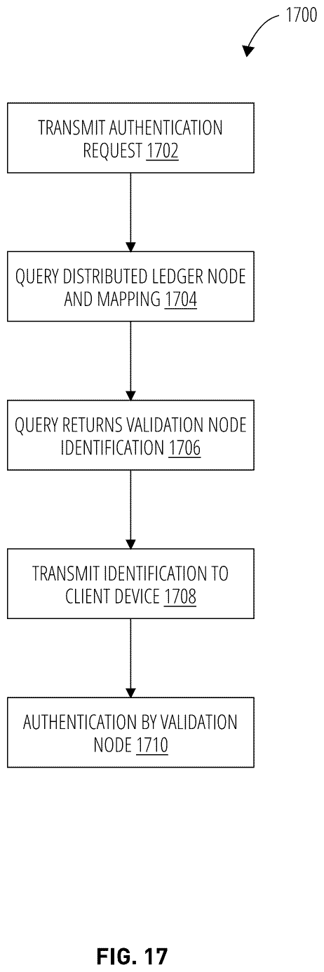

FIG. 17 illustrates a method 1700 performed by a distributed network authentication system according to an example embodiment. For example, the method can be performed by distributed network authentication system 1600 and or by another distributed network authentication system.

In block 1702, a client device can transmit an authentication request to a client node. The authentication request can include, without limitation, a routing number, a software version number, and/or an applet version number. The request can be made by an API call or other communication between the client device and the client node.

In block 1704, after receiving the authentication request, the client node can transmit a query (e.g., via an API call) to a distributed ledger node. The distributed ledger node contain a mapping, and the distributed ledger node can submit the query to the mapping.

In block 1706, the query can return an identification of a validation node and/or a validation node address, and the distributed ledger node can transmit this identification to the client node.

In block 1708, the client node can transmit the identification to the client device. After receiving the identification, the client device can proceed with authentication with the identified validation node and/or validation node address, in block 1710.

What is claimed is:

1. A method comprising:
accessing, by a computing device, a merchant server hosting a website or application, the website or application requiring personal data associated with a user account to process a transaction, the personal data being stored on an issuer server associated with a contactless card associated with the user account;
receiving, by the computing device, a request from the merchant server to authenticate the user account, the request including a query from the merchant server to determine an authentication method by which the contactless card associated with the user account will authenticate the user account;
receiving, by the computing device from the contactless card, the response to the query, the response indicating the authentication method to be used by the contactless card;
sending, by the computing device, the response indicating the authentication method to a node in a switching network to extract information from the response and use the extracted information to determine the issuer server associated with the contactless card;
forwarding, by the computing device, an authentication request based on the indicated authentication method from the node in the switching network to the contactless card;
forwarding, by the computing device from the contactless card, an authentication response to the node in the switching network, wherein the node is to initiate authentication of the authentication response with the issuer server; and
processing, by the computing device, a transaction with the merchant server, whereby the transaction is processed using the personal data that was sent from the node in the switching network to the merchant server as a result of the authentication by the node.

2. The method of claim 1, wherein the response to the query indicates that the authentication method to be used by the contactless card will be a fast identity online (FIDO) authentication method, wherein the authentication request comprises a FIDO authentication challenge, wherein the authentication response comprises a signed FIDO response using a FIDO private key, and wherein authenticating the authentication response comprises authenticating the signed FIDO response.

3. The method of claim 2, further comprising retrieving, by the computing device, protocol information about the contactless card using a FIDO client device to authenticator protocol (CTAP) communication between the computing device and the contactless card.

4. The method of claim 3, wherein retrieving the protocol information includes determining the protocol information from the signed FIDO response and the authenticator attestation global unique identifier (AAGUID) of the contactless card.

5. The method of claim 4, wherein the information extracted from the response includes the protocol information from the AAGUID.

6. The method of claim 1, wherein the personal data includes at least payment credentials and personal information of the user account for shipping or delivery.

7. The method of claim 1, further comprising determining, by the computing device, the authentication method using sequential selection of AID.

8. The method of claim 1, wherein forwarding the response indicating the authentication method to the node in the switching network includes forwarding a user account identifier with the response, wherein the node in the switching network is to use the information extracted from the response with the user account identifier to query a database to determine the issuer server associated with the contactless card.

9. A method comprising:
receiving, at a merchant server hosting a website or application, a transaction request from a computing device associated with a user account, the website or application requiring personal data associated with the user account to process the transaction request, and the personal data being stored on an issuer server associated with a contactless card associated with the user account;
sending, by the merchant server to the computing device, a request to authenticate the user account, the request including a query to determine an authentication method by which the contactless card associated with the user account will authenticate the user account;
receiving, by the merchant server, a response from the contactless card to the query, the response indicating the authentication method to be used by the contactless card;
forwarding, by the merchant server, the response to the query to a node in a switching network to extract information from the response, and use the extracted information to determine the issuer server associated with the contactless card, wherein the node in the switching network is to initiate authentication with the issuer server;
receiving, by the merchant server from the node in the switching network, the personal data associated with the user account; and
processing, by the merchant server, the transaction request using the personal data received from the node in the switching network.

10. The method of claim 9, wherein the response to the query indicates that the authentication method to be used by the contactless card will be a fast identity online (FIDO) authentication method, wherein the merchant server forwards a FIDO response signed by the contactless card to the node in the switching network to perform FIDO authentication.

11. The method of claim 10, further comprising receiving, by the merchant server, protocol information about the contactless card retrieved by a computing device using a FIDO client to authenticator protocol (CTAP) communication between the computing device and the contactless card.

12. The method of claim 11, wherein retrieving the protocol information includes determining the protocol information from the signed FIDO response and the authenticator attestation global unique identifier (AAGUID) of the contactless card.

13. The method of claim 9, wherein the personal data includes at least payment credentials and personal information of the user account for shipping or delivery.

14. The method of claim 9, wherein forwarding the response indicating the authentication method to the node in the switching network includes forwarding a user account identifier with the response, wherein the node in the switching network is to use the information extracted from the response with the user account identifier to query a database to determine the issuer server associated with the contactless card.

15. The method of claim 9, wherein a client software development kit (SDK) of the merchant server generates and sends the request, including the query, to the computing device to be forwarded to the contactless card.

16. A method comprising:
receiving, at a node in a switching network, a message indicating an authentication method by which a contactless card will verify an identity of a user associated with a user account for processing a transaction with a merchant server, the merchant server requiring personal data regarding the user to process the transaction;
extracting, by the node in the switching network, information from the message to determine an issuer server associated with the contactless card and the user account;
sending, by the node in the switching network to the contactless card, an authorization request using the information extracted from the message; and
initiating, by the node in the switching network, an authentication of an authentication response from the contactless card with the issuer server and therefore verifying the identity of the user associated with the contactless card, wherein the node in the switching network sends the personal data to the merchant server and the transaction is processed using the personal data.

17. The method of claim 16, further comprising retrieving, by the node in the switching network, the personal data from the issuer server.

18. The method of claim 16, wherein the message indicates that the authentication method to be used by the contactless card will be a fast identity online (FIDO) authentication method, wherein the authentication request comprises a FIDO authentication challenge, wherein the authentication response comprises a signed FIDO response using a FIDO private key, and wherein authenticating the authentication response comprises the issuer server authenticating the signed FIDO response.

19. The method of claim 18, further comprising identifying, by the node in the switching network, a merchant identification associated with the merchant server, identifying a FIDO key associated with the merchant identification, wherein the issuer server can verify the authentication response using the FIDO key associated with the merchant identification.

20. The method of claim 16, further comprising generating, by the node in the switching network using the personal data and the signed FIDO response, an authorization token to process future transaction requests, the authorization token including an indication that the FIDO private key has already been verified for the user account, and verification of the FIDO private key is not needed for future transactions to be processed.
